(19) United States
(12) Patent Application Publication
(10) Pub. No.: US 2025/0016142 A1
(43) Pub. Date: Jan. 9, 2025

(54) METHODS TO ADD ZERO-TRUST ACCESS-CONTROL TO A DETERMINISTIC INTERNET NETWORK TO ACHIEVE QUANTUM SAFE CYBER-SECURITY

(71) Applicant: Tadeusz H. Szymanski, Toronto (CA)

(72) Inventor: Tadeusz H. Szymanski, Toronto (CA)

(21) Appl. No.: 18/640,977

(22) Filed: Apr. 19, 2024

Related U.S. Application Data
(60) Provisional application No. 63/461,124, filed on Apr. 21, 2023.

(51) Int. Cl. H04L 9/40

(52) U.S. Cl. CPC H04L 63/0485

(57) ABSTRACT

Methods to add an “Admission Control/Access Control” system to control access to a “Software-Defined-Deterministic Industrial Internet of Things” (SDD-IIoT) network are described. The SDD-IIoT comprises a “Software Defined Networking” (SDN) control-plane, and many “Software-Defined-Deterministic Wide Area Networks” (SDD-WANs). The SDN control-plane comprises 3 layers of “Zero Trust Architectures”, i.e., rule-based “Attribute-Based Access Control” (ABAC) systems, where subjects can request access to resources. A controller's “Knowledge-Base” consists of a set of facts and rules, which an inference-engine processes to make access decisions. Each SDD-WAN comprises a low-complexity deterministic forwarding-plane, with many simple deterministic packet switches (D-switches), realized with “Field Programmable Gate Arrays” (FPGAs). The forwarding-plane implements “Authenticated Encrypted Deterministic Channels” (AEDCs or D-flows) directly in hardware in layer-3, using Quantum Safe ciphers. Each D-flow has a deterministic data-rate requirement, with delay and jitter requirements. The D-switches can forward encrypted data, according to pre-defined periodic (repeating) deterministic schedules. For a packet to be accepted at the destination, it must be successfully decrypted at the destination in layer-3, using a Quantum Safe cipher. Malicious packets from cyber-attackers will fail the decryption process in layer-3, and thus be detected and removed. Each enterprise has an “Enterprise-Controller”, to control access to its private resources (i.e., computers, data-bases, etc), with an extensive knowledge base of rules. Each SDD-WAN has a “WAN-Controller”, to control the communications between enterprises over the SDD-WAN. If an Enterprise-Controller or WAN-Controller approves a request to establish a new D-flow, the SDN control-plane will download deterministic schedules and secret keys to the D-switches in the forwarding-plane. An IIoT-Controller will control the communications between different SDD-WANs. In an IIoT deployment, there may be 10s of WAN-Controllers, each with 100s of Enterprise-Controllers. These collaborative controllers work together, to control access to the bandwidth of the SDD-IIoT. They can achieve exceptionally-strong cyber-security, where the expected number of successful cyber-attacks per year from external cyber-attackers with Quantum Computers, can be reduced to zero. The SDD-IIoT can achieve security comparable to that offered by “Quantum Key Distribution” (QKD) networks in practice, determined by the computational hardness of cracking Quantum Safe ciphers. The SDD-IIoT can save the industry 10s . . . $100s of billions (US dollars) per year, by exploiting low-cost FPGAs, providing a powerful incentive to innovate layer-3 of the Internet.

### CROSS-REFERENCE TO RELATED APPLICATIONS

This application claims the benefit of the filing date of U.S. provisional application No. 63/461,124, filed on Apr. 21, 2023, the entire contents of which are incorporated by reference herein.

### FIELD OF THE INVENTION

The present invention relates, generally, to communications networks, devices and methods and, more particularly, to methods, software and hardware designs to improve the performance and achieve Quantum Safe cyber-security of the Internet network, data center networks, local area networks, wireless networks, optical networks and other forms of networks.

### BACKGROUND OF THE INVENTION

The current “Internet of Things” (IoT) provides services to consumers and is called the “Consumer IoT.” It provides no “Admission Control/Access Control” (AC/AC) system to control access to resources. According to Cisco, the Consumer IoT will, in 2024, interconnect over 30 billion devices, which communicate using the known “Internet Protocol” (IP) in the so-called “network” layer (also known as layer-3). Given the lack of any AC/AC system in the Consumer IoT, any of these 30+ billion IoT devices can send data to any other IoT devices in layer-3, at any data rate and at any time. As a result of this uncontrolled behavior, the Consumer IoT may be shown to suffer from significant congestion and a phenomenon called “BufferBloat.” BufferBloat may be used to refer to a condition in which Internet routers become severely congested and buffer millions of packets. During times of congestion, the delays for a packet to traverse the Internet can reach ¼ or ½ a second. The routing algorithms used in the Internet may also be shown to be insecure and vulnerable to cyber-attacks. Hence, it may be considered that the Consumer IoT cannot offer any deterministic “Quality of Service” (QoS) guarantees to users, i.e., the Consumer IoT cannot provide strict guarantees on the delay or jitter of packets. The Consumer IoT cannot even guarantee that packets will be delivered to the correct destination.

A next-generation IoT is expected to support Industrial Automation and “Industry 4.” Industry 4 is a term used to describe the fourth wave of the Industrial Revolution. Industry 4 will enable many smart “Cyber-Physical Systems” to access the IoT. “Smart Manufacturing” systems and “Smart Factories” will automate and transform industrial manufacturing in the 21^{st} century. These smart systems are also expected to include a new wave of “Smart Infrastructure” systems, which have access to the Internet and are controlled over the Internet. These systems include “Smart Transportation Systems,” a “Smart Power Grid” and “Smart Cities.” A desire to support these smart systems has lead to the concept of an “Industrial Internet of Things” (Industrial IoT or IIoT). Ideally, the IIoT will provide communication services between industrial devices and will provide deterministic QoS guarantees on the delay and jitter. Ideally, the IIoT will provide a deterministic (i.e., guaranteed) data-rate to each connection, with guaranteed delivery of data with very low or “ultra-low” latency and with very low jitter. In 2024, the goals of the IIoT described above are elusive idealized goals, that have never been achieved.

The current Internet can be described using a well-known model with 7-layers of abstraction: (1) the physical layer, (2) the data-link layer, (3) the network layer, (4) the transport layer, (5) the session layer, (6) the presentation layer, and (7) the application layer. The current Consumer IoT relies upon the “Internet Protocol” (IP) in layer-3. The IP is used by devices to send data that is formatted in IP packets. Each IP packet has a header that contains data to identify a sender (i.e., the packet source) and a desired destination. IP version 4 (IPv4) uses 40-bits to identify the sender or destination of a packet. 32 bits, among the 40 bits, are used for an IPv4 address and 8 bits are used for a “port number.” Packets traverse a series of IP-routers from the source to the destination. Each IP-router receives an IP packet, examines the IP packet header to identify the destination, finds the preferred outgoing link from a lookup table (i.e., the IP-router makes a “routing” decision) and sends the packet to the next IP-router.

Unfortunately, the Internet protocol is over four decades old and may be shown to suffer from many serious cyber-security vulnerabilities that have existed in layer-3 for many decades. One vulnerability relates to the use of unencrypted IP packet headers. A cyber-attacker with access to the transmission medium (optical fiber, Ethernet cables, or wireless spectrum) can observe a packet transmission and, often, the cyber-attacker can change the IP packet-header to create a cyber-attack. Another vulnerability relates to the use of unauthenticated packet-headers. There is no way for the destination to confirm that the sender is who they claim to be. Hence, cyber-attackers can easily change IP packet-headers so that the sender appears to be a trusted peer. A further vulnerability relates to the use of “middle-boxes,” which perform many of the functions that allow the Internet to operate. Such functions include “Network-Address-Translation,” load-balancing and intrusion detection. Unfortunately, middle-boxes are often insecure, meaning that a given middle-box may be compromised by a cyber-attacker. A cyber-attacker may then compromise all IP packets that pass through the given middle-box and re-route these packets to destinations under the control of the cyber-attacker. An even further vulnerability relates to the use of insecure layer-3 routing protocols, such as the “Border Gateway Protocol” (BGP). A cyber-attacker can easily change the lookup tables used in an IP-router to, thereby, send packets to a destination that they control. A still further vulnerability relates to a reliance upon a large number of “Domain Name Servers” (DNSs). DNSs translate text representing a destination (i.e., www.google.com), into a numeric IP address. Unfortunately, DNSs are often insecure and can be compromised by a cyber-attacker. A cyber-attacker may compromise a DNS to cause the DNS to return a malicious numeric IP address and, thereby, re-route packets to a destination that they control. It may be shown that the Internet protocol provides no inherent “Admission Control,” “Access Control” or “Rate Control.” Any of the billions of IoT devices can send data to any of the other billions of IoT devices at any data-rate and at any time. Hence, it may be shown that severe congestion occurs frequently. During such congestion, an IP-router may buffer 10s to 100s of millions of packets as those packets await service. Queuing delays through a congested router can reach 100s of milliseconds, or more. In addition, each nation experiences a large number of “external” cyber-attacks from cyber-attackers operating in foreign countries, given the lack of access control.

The above vulnerabilities of IP have weakened the Consumer IoT for decades, i.e., the Consumer IoT suffers from millions of successful cyber-attacks per year. There are many well-known types of cyber-attacks, including: (1) “Spoofing” cyber-attacks, in which a cyber-attacker changes the IP-address of a packet, to appear to be another party; (2) “Man-in-the-Middle” attacks, in which a cyber-attacker interposes itself between two parties, who believe they are talking to each other in confidence; (3) “Replay” cyber-attacks, in which a legitimate IP packet is read, copied and re-inserted into the network a later time to gain access to resources.

Another attack, which has attracted significant attention, is the “Harvest Now, Decrypt Later” cyber-attack. In this attack, a cyber-attacker records encrypted communications observed in layer-3. The cyber-attacker is typically a foreign nation-state actor. The cyber-attacker may retain these recordings until they develop a computer (e.g., a quantum computer) that is able to decrypt the recorded communications. Communications transmitted over layer-3 are often encrypted using public key cryptography such as RSA (“Rivest-Shamir-Adleman”) public key ciphers and it is expected that quantum computers will be able to crack RSA ciphers by about 2030. Governments typically expect that encrypted data will remain secret for several decades, but the prospect of quantum computers allows for a possibility that communications encrypted today may be vulnerable to attack (e.g., decryption) within a decade.

Two types of cyber-attacks require special attention because of their sheer volume: “Denial of Service” (DoS) attacks; and “Distributed Denial of Service” (DDoS) attacks. According to the cyber-security firm Norton, these attacks have been called the “most powerful weapons on the Internet.” These attacks can target web-servers, IP-routers, middle-boxes and Domain-Name-Servers. These attacks involve flooding targeted devices with far more traffic than the targeted devices are able to handle, thereby resulting in a loss of service. According to Cisco, the Consumer IoT is expected to experience about 17.5 million successful DoS/DDoS attacks in 2024. The compound annual growth rate is about 14% and, hence, the Consumer IoT is expected to experience about 20 million successful DoS/DDoS attacks in 2025.

Several companies offer layer-3 networks that, as a commercial service, attempt to detect and eliminate many cyber-attacks. For example, the cyber-security firm Cloudflare has a global IoT network that spans over 300 cities in 100 countries. The Cloudflare network serves up to 64 million HTTP (Hypertext Transfer Protocol) requests per second at peak times and serves about 2.3 billion Domain Name Server (DNS) queries each day. Cloudflare mitigated over 140 billion cyber-threats per day in 2023 (each cyber-threat requiring one or more layer-3 IP packets). In the third quarter of 2023, Cloudflare detected and mitigated 8.9 trillion HTTP DDoS attack threats in layer-3, representing about 96 billion DDoS attack threats per day. Cloudflare estimates that the average DDoS attack lasted 8 hours in 2022, rending the targeted services unavailable for significant periods of time (several minutes or hours). Kaspersky Labs estimates that about 20% of DDoS attacks last for weeks.

In January 2024, at the annual meeting of the “World Economic Forum” in Davos, Switzerland, the largest US bank, “JPMorgan Chase,” reported that it receives about 45 billion Internet accesses per day (i.e., layer-3 IP packets), many of which are attempted cyber-attacks. JPMorgan Chase reported spending USD $15 billion a year on technology and that employing 62,000 technologists each year, more than Google or Amazon, many to fight cyber-attacks. In 2023, Google, Amazon, Microsoft and Cloudflare suffered record-setting DDoS attacks, with an intensity of about 200 million IP packets per second. DDoS attacks are also used as weapons of war, as the war between Ukraine and Russia illustrates. Clearly, the world is in the midst of a deep cyber-security crisis, which grows deeper every year.

In 2008, the US National Academy of Engineering identified 14 “Grand-Challenge” problems for the 21-st century. These problems include achieving: (a) energy from fusion; (b) clean water for the world; (c) carbon sequestration to combat climate-change; and (d) “Security in Cyberspace.” Many innovative approaches to address the cyber-security crisis are being explored, including, e.g., Artificial Intelligence (AI) approaches, Machine Learning approaches, Deep Learning approaches and Blockchain-based approaches. However, the cyber-security crisis persists. The world is also exploring quantum technologies to address the cyber-security crisis, including the following: (i) “Quantum Key Distribution” (QKD) networks; and (ii) hybrid “Classical-Quantum” networks. In principle, QKD networks can deliver “perfectly secret” keys to users. These keys are considered to be guaranteed by the laws of physics and to achieve perfect cryptographic security. However, QKD networks have several vulnerabilities (e.g., to DoS and internal cyber-attacks) and the US National Security Agency does not recommend their use. The US DARPA (“Defense Advanced Research Projects Agency”) initiated a research program in 2023 to explore whether a hybrid Classical-Quantum network that blends classical and quantum communications can “produce a scalable, vastly more secure networking infrastructure.”

It should be noted that QKD networks provide “cryptographic security”, i.e., QKD networks ensure that data transmitted over layer-3 is confidential and cannot be decrypted by an eavesdropper (in principle). However, QKD networks cannot authenticate the sender. It is well-known that QKD networks need “authenticated classical channels,” to authenticate each end of a communications channel. It may be shown that QKD networks do not eliminate the vast majority of cyber-security vulnerabilities in layer-3 of the Consumer IoT. According to the US National Security Agency, QKD networks do not eliminate DoS/DDoS attacks in layer-3 and do not eliminate internal cyber-attackers. (Internal cyber-attackers have managed to obtain a copy of the secret key(s) needed to access a system.) Cloudflare has reported that it mitigated 8.9 trillion DoS/DDoS attacks threats in the 3rd quarter of 2023, representing about 96 billion attack threats per day. The use of a QKD network will not eliminate these cyber-threats. Thus, the US National Security Agency does not recommend QKD networks. The French ANSSI (“Agence Nationale de la Sécurité des Systèmes d'information”), also called the “National Cybersecurity Agency of France.” does not recommend the use of QKD networks and states: “QKD networks may find some use in a few niche applications. However, the use of state-of-the-art classical cryptography including post-quantum algorithms is by far the preferred way to ensure long term protection of data. The cost incurred by the use of QKD should not jeopardize the fight against current threats to information systems which overwhelmingly do not exploit cryptographic weaknesses.”

The France ANSSI states “current threats to information systems . . . overwhelmingly do not exploit cryptographic weaknesses.” The truth of this statement is apparent from Cloudflare's statistics. Cloudflare mitigates about 140 billion cyber-threats each day, including about 96 billion DDoS attack threats each day. It may be shown that the use of QKD networks will not eliminate these threats, since these attacks do not exploit cryptographic weaknesses. These attacks are a result of a vulnerable IP protocol and its use in layer-3.

### SUMMARY OF THE INVENTION

Aspects of the present application address one of the US NAE “Grand-Challenge” problems, to achieve “Security in Cyberspace” for industrial automation and critical infrastructures. Aspects of the present application relate to showing how external cyber-attacks can be eliminated by introducing an “Admission Control/Access Control” (AC/AC) system to control access to bandwidth of a simple deterministic forwarding-plane in layer-3. (An external cyber-attacker does not have access to the secret keys needed to access a secured machine.) In a deterministic system, the timeline in which future events unfold can be predetermined, i.e., all events happen according to predetermined times. This concept can be exploited to achieve exceptionally strong Quantum Safe cyber-security, that external cyber-attackers with Quantum computers cannot compromise, as explained in the reference paper by T. H. Szymanski entitled “The ‘Cyber-Security via Determinism’ Paradigm for a Quantum Safe Zero Trust Deterministic Internet of Things,” IEEE Access 10, 2022, which is hereby incorporated by reference. The methods and designs proposed in the present application may be used to solve problems that have existed in the Consumer IoT for decades and may be used to improve the performance and achieve Quantum Safe cyber-security of many types of deterministic networks, including the proposed Industrial IoT, networks based upon Multi-Protocol Label Switching (MPLS) technology, optical deterministic networks, fifth generation (5G) wireless deterministic networks, sixth generation (6G) wireless deterministic networks and deterministic radio-access-networks.

In view of its poor performance, the Consumer IT is also typically “over-provisioned” to operate at light loads to reduce delays, jitters and packet loss rates. With over-provisioning, each link in the Consumer IoT may be shown to operate at a fraction of its peak capacity, typically less than about 30%. This over-provisioning is estimated to cost service-providers globally $100s of billion US (USD) per year, in excess capital costs and energy costs. Even with over-provisioning, excessive delays still occur frequently during times of congestion.

To summarize, the existing Consumer IoT may be considered to be a “Best-Effort” (BE) network. Indeed, the existing Consumer IoT may be shown to suffer from severe congestion, excessive delays, excessive costs, excessive energy use and exceptionally poor cyber-security. The Consumer IoT provides only Best-Effort service for consumers with no guarantees on the bandwidth, delay or jitter of a consumer's Internet connection(s). Today's Consumer IoT relies upon the Internet protocol. The Internet protocol may be shown to have many fundamental vulnerabilities that cause its poor performance and poor-cyber-security and these vulnerabilities have existed in the Consumer IoT for many decades. These problems will be addressed in the present application.

In the present application, methods and designs are presented that add an “Admission Control/Access Control” system to control a deterministic forwarding-plane to, thereby, provide deterministic services with exceptionally-strong Quantum Safe cyber-security to a proposed deterministic Industrial IoT network, with immunity to cyber-attacks from external cyber-attackers with Quantum computers, are presented. Users can request the establishment of “Authenticated Encrypted Deterministic Channels” (AEDCs) in layer-3, which are immune to cyber-attacks from external cyber-attackers with Quantum computers. (AEDCs are also called “deterministic traffic flows”, or “D-flows”). If the request is approved by the AC/AC system, the network will establish the AEDC in layer-3 hardware, to eliminate the use of IP with all its vulnerabilities. Each AEDC is immune to congestion and interference from other traffic flows. Each AEDC is immune to external cyber-attacks and DoS/DDoS attacks, given the AC/AC control-system. The proposed Industrial IoT can achieve a level of cryptographic security comparable to that of QKD networks achieved in practice, determined by the computational hardness of cracking “Symmetric Key Cryptography” (SKC). The proposed Industrial IoT may also eliminate the estimated 100+ billion cyber-threats per day, which occur in layer-3 that Cloudflare mitigates, which do not exploit cryptographic weaknesses, such as DDoS attacks. Thus, the proposed Industrial IoT may be shown to be considerably more secure than QKD networks, when DDoS attacks are considered.

Aspects of the present application may be shown to support the growth of smart Cyber-Physical Systems in the 21^{st} century. The future “Smart Power Grid” may reserve its own congestion-free and interference-free “Deterministic Virtual Private Network” (D-VPN) to support its communications, with exceptional cyber-security. Every government department (e.g., Department of Defense, Department of National Security) can reserve its own congestion-free D-VPN, to support its communications, with exceptionally-strong Quantum Safe cyber-security (with immunity to cyber-attacks from external cyber-attackers with Quantum computers). It is expected that cloud service providers, including companies such as Netflix, Google, Amazon Web Services, Apple and Microsoft, may implement their own deterministic forwarding-planes, with exceptional performance and Quantum Safe cyber-security, given the significant cost-savings that can be achieved. It is further expected that these service providers may offer new services to customers, e.g., customers may lease their own D-VPNs, with exceptional performance and Quantum Safe cyber-security, for a monthly fee from a number of service providers.

A “Software-Defined-Networking” (SDN) control-plane, proposed herein, may also efficiently and securely manage ciphers and secret keys for millions or billions of IoT users and devices. The SDN control-plane may be shown to provide IoT users and devices with encrypted communications with secret keys in layer-3, given a plurality of ciphers of choose from. The SDN control-plane may keep a record of all ciphers in use and all secret keys in use at any time. Existing encryption schemes for the Consumer IoT include the RSA public key encryption scheme, the US “Advanced Encryption Standard” (AES) and the ChaCha20 stream cipher. (There are many other ciphers that can be used as well.) There is growing international concern about the potential ability of quantum computers to break existing encryption schemes such as RSA in the next decade. Data will reside on disks and in data-centers for decades and it is desirable to have a plurality of encryption schemes, which may have shorter keys (a few hundred bits) and also very long keys (a thousand bits or more), to provide protection against quantum computers. An efficient and secure system to manage the ciphers and the encryption keys for billions of IoT users is therefore needed. In this disclosure, it is shown that the low-complexity SDN control-plane can maintain a large number of secret keys, for a plurality of ciphers, to enable secure communication channels to all the devices in the deterministic Industrial IoT that it controls. The SDN control-plane can also create secret keys for every new AEDC that it establishes in layer-3 and it can send these secret keys to the communicating parties, over highly encrypted channels.

A “Field Programmable Gate Array” (FPGA) is a type of integrated circuit, where the functionality can be programmed in the field. In contrast, an “Application Specific Integrated Circuit” (ASIC) is an integrated circuit designed for one specific function. A state-of-the-art FPGA may have about 40 billion transistors in 2024. Assume 10 transistors may be used to create a “programmable binary gate” or one bit of high-speed static memory. Assume one transistor may be used to create one bit of slow dynamic memory. It follows that a state-of-the-art FPGA in 2024 could contain potentially one billion simple programmable binary logic gates, one billion bits of high-speed memory and about 20 Gigabits of slow dynamic memory with an ability to reach clock-rates of up to 500 MHz. Using today's design techniques, a typical IP router requires buffers for a fraction of second of data to, thereby, provide congestion control for worst-case scenarios. Using existing design techniques, a typical IP router with four Terabits per second (Tbps) of bandwidth and with buffers for ¼ of a second of data will require buffers for about 1,000 Gigabits of data. Clearly, it would difficult to synthesize a four Tbps IP router into a single FPGA or ASIC using today's design techniques, due to the vast amount of buffering involved.

FPGAs may soon be integrated with Silicon-Photonics transceivers, comprising electrical-to-optical (EO) converters and optical-to-electrical (OE) converters, residing on a single integrated circuit package. The integrated circuit package could contain one or more integrated circuits, packaged together into a single “package”. The low-complexity “deterministic packet switches” (D-switches) described in this disclosure may be shown to reduce buffer sizes by a factors of between 100,000 and 1,000,000 times, compared to a Best-Effort IP router. Experimental results show that a simple D-switch can function correctly while buffering at most a few hundred packets per switch and, often, much less. Therefore, by using the methods and design techniques proposed in this disclosure, it will be possible to integrate the proposed low-complexity D-switch, into a single integrated circuit package, containing one or more FPGAs or ASICs. Aspects of the present application may be shown to utilize low-complexity encryption and decryption schemes, i.e., Chacha20, many of which can be realized on a single FPGA or ASIC integrated circuit.

Aspects of the present application relate to a low-complexity “Software-Defined-Networking” (SDN) control-plane with an “Admission Control/Access Control” (AC/AC) system to control a low-complexity deterministic forwarding-plane in layer-3. The SDN control-plane may include many simple deterministic packet switches. The AC/AC system may include three levels of hierarchical rule-based “Zero Trust Architecture” (ZTA) controllers to control access to resources. In a unique design, the controllers may control access to bandwidth of the deterministic forwarding-plane, so that only authorized entities can access layer-3 (the “network” layer) and send/receive data over layer-3. It is shown that an AC/AC system can control a simple deterministic forwarding-plane to deliver deterministic (or guaranteed) service to many deterministic traffic flows, with exceptionally low latencies, with up to 100% utilization and with exceptionally strong cyber-security. The combination of (i) the proposed AC/AC system and (ii) a low-complexity deterministic forwarding-plane may be shown, in practice, to eliminate all external cyber-attacks and achieve a level of cryptographic-security comparable to that achieved by “Quantum Key Distribution” (QKD) networks. To utilize aspects of the present application, the AC/AC control system and a new low-complexity forwarding-plane utilizing “Field Programmable gate Arrays” (FPGAs) can be added to the Internet, to provide deterministic services with exceptionally strong cyber-security.

In accordance with one aspect of the invention, a design and methods are proposed for a low-complexity SDN control-plane realize an “Admission Control/Access Control” (AC/AC) system to control access to a new low-complexity deterministic forwarding-plane in layer-3, comprising low-complexity “deterministic packet-switches” (D-switches). The AC/AC system comprises three levels of collaborating hierarchical controllers called: (i) Enterprise-Controllers; (ii) WAN-Controllers; and (iii) IIoT-Controllers. Each controller is a rule-based “Zero Trust Architecture” controller, where administrators can easily add new rules to control access to critical resources. In this disclosure, a new and unique approach is taken. The AC/AC system will strictly control access to the bandwidth of a deterministic forwarding-plane in layer-3 of the Internet, specifically by requiring that: (i) all data-transmissions originate at an authorized and authenticated sender (i.e., an approved deterministic transceiver); (ii) all data-transmissions within a D-VPN in layer-3 are encrypted with Quantum Safe ciphers, a concept that has never been previously applied to a large network such as the Internet. (Encryption is usually applied in layers 4 and higher.) For data to be accepted at a receiver in a layer-3 D-VPN, the data must first be decrypted and then authenticated. However, it is effectively impossible for a cyber-attacker to crack a Quantum Safe cipher, in order to successfully send data over the proposed forwarding-plane in layer-3.

In accordance with another aspect of the invention, the introduction of an AC/AC control-system to control access to bandwidth of a deterministic forwarding-plane, may be shown to address an outstanding “Grand-Challenge” problem of the 21-st century, the problem of achieving “Security in Cyberspace” for industrial automation and critical infrastructures. An SDN control-plane with a programmable rule-based AC/AC control system is introduced to control access to a simple deterministic forwarding-plane for the proposed Industrial IoT. The forwarding-plane does not perform any processing of layer-3 IP packet headers and the forwarding-plane does not perform any routing or scheduling of layer-3 IP packets, as these tasks have been migrated up into the SDN control-plane. This unique combination may significantly improve the cyber-security of the Industrial IoT. Rules can be written prevent the un-authorized transmission of data in layer-3 of the Industrial IoT. Even a single un-authorized packet transmission in layer-3 can be detected. Furthermore, the D-switches and deterministic transceivers can monitor all traffic in the forwarding-plane, to detect and eliminate all unauthorized traffic. The D-switches and deterministic transceivers can implement “Guaranteed Intrusion Detection Systems” to detect external cyber-attacks.

In accordance with another aspect of the invention, the SDN control-plane may also be used to manage the security of billions of AEDCs within the Industrial IoT, by managing the ciphers used and the secret keys used for the encryption/decryption and authentication of each AEDC. AEDCs can use a plurality of encryption schemes, including: (i) extensions of the US “Advanced Encryption Standard” (AES) to handle larger keys; and (ii) extensions of the Chacha20 cipher to handle larger keys. AEDCs can be assigned a high level of security (using 256-bit secret keys), a very-high level of security (using 512-bit secret keys), or an exceptionally high level of security (using greater than 512 bits of secret key). The use of a plurality of ciphers offers diversity and the use of larger keys provides additional security to address the threats of quantum computers. Algorithms standardized by the US NIST (“National Institute of Standards and Technology”) Post Quantum Cryptography standardization effort can also be supported.

In accordance with another aspect of the invention, use of an AC/AC control system to control a low-complexity forwarding-plane of simple deterministic packet switches (D-switches), enables the use of FPGAs and ASICs to implement the D-switches. The migration of the routing and scheduling tasks into the SDN control-plane has lead to a dramatic simplification of the D-switches. The amount of buffering required in a D-switch may be reduced by a factor of 100,000-1,000,000 times, when compared to the amount of buffering needed in a layer-3 IP router. Thus, a D-switch can be realized with one (or a few) integrated circuits, packaged into a single integrated circuit package. The use of low-cost FPGAs (or ASICs) can lead to the savings of $10s . . . $100s of billions (US Dollars-USD) annually, in reduced capital costs and operational costs.

In accordance with another aspect of the invention, use of an AC/AC control system to control a low-complexity forwarding-plane of simple deterministic packet switches (D-switches) enables the use of prioritized traffic classes within the D-switches. When prioritized traffic classes are used in the forwarding-plane, a single queue can buffer the packets for a plurality of AECDs. The single queue, representing a class of traffic, can receive deterministic service under the control of the SDN control-plane. When that queue receives service, packets may be selected for service according to a simple “First Come First Served” (FCFS) policy. (Any other simple policy can be used too, i.e., a random selection policy). The use of prioritized traffic classes can simplify the design of a D-switch, by having a smaller number of queues to receive deterministic service, each buffering packets for a plurality of AEDCs 22.

In accordance with another aspect of the invention, the introduction of AC/AC system to control a new forwarding-plane of low-complexity deterministic packet switches may eliminate several serious security vulnerabilities that have existed in the Consumer IoT for many decades. These IP vulnerabilities may be eliminated: (i) the use of unencrypted IP packet headers; (ii) the use of unauthenticated IP packet headers; (ii) the use of insecure middle-boxes; (iv) the use of insecure layer-3 routing protocols; (v) the use of insecure layer-3 Domain Name Servers (DNSs). As a result, all interference and congestion between D-flows in layer-3 may be eliminated and all “BufferBloat” may be eliminated. External cyber-attacks may be eliminated and the vulnerability to internal cyber-attacks may be greatly reduced. The amount of buffering required in a deterministic packet switch may be reduced by a factor of 100,000-1,000,000 times, when compared to the amount of buffering needed in a layer-3 IP router. The AC/AC system may control access to the bandwidth of every transmission link in the deterministic forwarding-plane, to ensure these results.

In accordance with another aspect of the invention, the introduction of an Enterprise-Controller may allow each enterprise to create a collection of rules (called a “knowledge base”), to control access to its own resources, including access to layer-3 communications. Requestors of resources can include: (i) people (e.g., employees, supervisors, senior management), (ii) computers, and (iii) software-programs. Resources under control could include: (i) computers or workstations; (ii) data-centers; (iii) data-bases; (iv) computer programs; (v) wireless networks; and (vi) a new forwarding-plane in layer-3 of a deterministic Industrial IoT. The AC/AC system can also control access to resources in the Consumer IoT, i.e., the use of a new forwarding-plane is not essential.

In accordance with another aspect of the invention, the introduction of a WAN-Controller may allow a service-provider to create a collection of rules (called a “knowledge base”), to control access to a “Wide Area Network” (WAN) that it owns. Service providers such as Google, Amazon Web Services, Microsoft or Apple may create their own simple deterministic WANs comprising a low-complexity forwarding-plane of simple deterministic packet switches to, thereby, improve the performance of their own systems and to offer new services to customers. These service-providers can create a knowledge base of rules, to control access to the resources they provide in their own WANs. Requestors of resources can include: (i) enterprises within the WAN; and (ii) the IIoT-controller, which may have a request from another WAN to access the resources of this particular WAN. Resources under control could include: (i) the ability to communicate over the WAN; (ii) data-centers within the WAN; (iii) web-servers within the WAN; (iv) data-bases within the WAN; and (v) specialized computer programs within the WAN.

In accordance with another aspect of the invention, the introduction of an IIoT-Controller may allow a government (or a collection of service-providers acting in unison) to administer the proposed deterministic Industrial IoT, which comprises several distinct deterministic WANs owned by service-providers. The IIoT-Controller has a collection of rules (a “knowledge base”), to control the communications between deterministic WANs in the Industrial IoT. Service-providers such as Google, Amazon Web Services, Microsoft or Apple may each have their own simple deterministic WANs to improve the performance of their own systems and to offer new services to customers. Requestors of resources can include: (i) enterprises within any one WAN; and (ii) the WAN-controllers, which manage the requests from an enterprise within one particular WAN, to access the resources in another WAN. Resources under control could include: (i) the ability to communicate between WANs within the IIoT; (ii) data-centers within one specific WAN; (iii) data-bases within one specific WAN; (iv) web-servers within one specific WAN; and (v) specialized computer programs within one specific WAN.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A illustrates a Venn-like diagram, illustrating the Consumer IoT and the Industrial IoT;

FIG. 1B illustrates the protocol-stack of the Consumer IoT;

FIG. 2 illustrates a rule-based “Attribute-Based Access Control” (ABAC) control system, in accordance with aspects of the present application;

FIG. 3 illustrates three layers of collaborating rule-based “Zero Trust Architecture” controllers in the proposed AC/AC control system, in accordance with aspects of the present application;

FIG. 4 illustrates the SDN control-plane and a deterministic forwarding-plane with low-complexity deterministic packet switches, in accordance with aspects of the present application;

FIG. 5A illustrates the protocol stack for the proposed Industrial IoT, which includes the proposed AC/AC system, in accordance with aspects of the present application;

FIG. 5B illustrates a proposed “Dual Pillar” protocol stack for the next-generation IoT, comprising a “Best-Effort” pillar for the Consumer IoT, and a deterministic pillar for the Industrial IoT, in accordance with aspects of the present application;

FIG. 6 illustrates a network of IP routers in layer 3, and a simple forwarding-plane, comprising simple deterministic packet-switches using FPGAs, operating in sub-layer-3a, in accordance with aspects of the present application;

FIG. 7 illustrates a simple forwarding-plane arranged in a USA topology, wherein two “Deterministic Virtual Private Networks” (D-VPNs) are embedded into the forwarding-plane, in accordance with aspects of the present application;

FIG. 8 illustrates a flow-table for a simple deterministic packet switch, in accordance with aspects of the present application;

FIG. 9 illustrates a periodic scheduling-frame with 16 time-slots, in accordance with aspects of the present application;

FIG. 10 illustrates a deterministic transceiver, used in the forwarding-plane, in accordance with aspects of the present application;

FIG. 11A illustrates a deterministic packet switch using “Input Queues” (IQs), in accordance with aspects of the present application;

FIG. 11B illustrates a “Virtual Output Queue” (VOQ) with sub-queues, in accordance with aspects of the present application;

FIG. 11C illustrates a decryption unit in a deterministic packet switch;

FIG. 11D illustrates a flow-table unit in a deterministic packet switch;

FIG. 12 illustrates a deterministic packet switch using “Crosspoint Queues” (XQs), in accordance with aspects of the present application;

FIG. 13 illustrates a flow-chart for the low-complexity SDN control-plane, in accordance with aspects of the present application;

FIGS. 14A-14D illustrate the results of a simulation experiment for a forwarding-plane spanning the USA, in accordance with aspects of the present application;

FIG. 14A illustrates the end-to-end queuing delay distribution for several D-flows in the USA network, in accordance with aspects of the present application;

FIG. 14B illustrates the jitter distribution averaged over all D-flows in the USA network, in accordance with aspects of the present application;

FIG. 14C illustrates the evolution of the number of packets buffered in a D-switch, for selected cities in the USA network, in accordance with aspects of the present application;

FIG. 14D illustrates the distribution of the number of packets buffered in a D-switch, for selected cities, in accordance with aspects of the present application; and

FIG. 15 illustrates a “Ball Grid Array” integrated circuit package, in accordance with aspects of the present application.

### ARTICLES INCORPORATED BY REFERENCE

The paper by T. H. Szymanski, entitled “The “Cyber-Security via Determinism” Paradigm in a Quantum Safe Zero Trust Deterministic Internet of Things,” IEEE Access, April 2022, Vol. 10, pp. 45893-45930, is hereby incorporated by reference. This paper proposes an SDN control-plane, with a control system to manage a simple deterministic forwarding-plane in the Internet. It states that the AES or Chacah20 ciphers (or any other Quantum Safe cipher) can be introduced into layer-3, to reduce cyber-attacks. It establishes that the number of external cyber-attacks can then be reduced to zero, even given external cyber-attackers with access to Quantum computers. It establishes that cost savings can reach $10s . . . $100s of billions (US dollars—USD) per year. It will hereafter be referred to as reference [1].

The paper by T. H. Szymanski, entitled “A Quantum-Safe Software Defined Deterministic Internet of Things (IoT) with Hardware-Enforced Cyber-security for Critical Infrastructure,” published online in Information, 2024, 15, 173, on Mar. 22, 2024, is hereby incorporated by reference. This paper expands on the control system to manage a deterministic forwarding-plane, proposed in reference [1]. This paper states that an “Authenticated Encryption” algorithm using the basic Chacha20 cipher may be used in layer-3. It establishes that the AEDCs can achieve a level of cryptographic cyber-security (i.e., protection from eavesdroppers) comparable to QKD networks in practice. It establishes that cost savings can reach $100s of billions (USD) per year. It will hereafter be referred to as reference [2].

The document by T. H. Szymanski, entitled “Supporting Consumer Services in a Deterministic Industrial Internet Core Network”, published in IEEE Communications Magazine, June 2016, Vol. 54, No. 6, pp. 110-117 (2016), is hereby incorporated by reference. This paper introduces a deterministic forwarding-plane for use in the Industrial IoT. It introduces deterministic packet switches using “Crosspoint Queues” (XQs). It establishes that that cost savings can reach $10s of billions (USD) per year. It will hereafter be referred to as reference [3].

The document by T. H. Szymanski, entitled “An Ultra-Low Latency Guaranteed-Rate Internet for Cloud Services”, IEEE/ACM Transactions on Networking, February 2014, Vol. 24, No. 1, pp. 123-136, is hereby incorporated by reference. It describes a deterministic forwarding-plane using deterministic packet switches with “Input Queues” (IQs). It introduces scheduling algorithms to schedule traffic within the D-switches, to minimize queue sizes and delays. It will hereafter be referred to as reference [4].

The paper by T. H. Szymanski, entitled “A Low-jitter Guaranteed-Rate Scheduling Algorithm for Packet-Switched IP Routers”, IEEE Transactions on Communications, 57(11), pp. 3446-3459, 2009, is hereby incorporated by reference. It describes a “Recursive Fair Stochastic Matrix Decomposition” (RFSMD) algorithm to decompose a traffic matrix T for a deterministic packet switch, to yield a deterministic periodic schedule for a crossbar switch, which minimizes queue sizes, delays and jitter. It will hereafter be referred to as reference [5].

The paper by T. H. Szymanski entitled “Maximum Flow Minimum Cost Routing in a Future Internet with Improved QoS Guarantees”, IEEE Transactions on Communications, 61(4), pp. 1485-1497, 2013, is hereby incorporated by reference. It presents algorithms to route a set of requests for traffic flows, through a network which modelled as a graph G(V,E), with vertices representing switches and edges representing transmission lines. It will hereafter be referred to as reference [6].

The patent by T. H. Szymanski, U.S. Pat. No. 1,076,209 B2, “Reduced Complexity Integrated Guaranteed-Rate Optical Packet Switch”, issued Jul. 27, 2021, is hereby incorporated by reference. It describes a deterministic forwarding-plane using deterministic switches (D-switches) with “Input Queues” (IQs), and D-switches with “Crosspoint Queues” (XQs). It eliminates the use of the IP protocol in layer-3, by migrating the tasks of routing and scheduling of packets into the SDN control-plane, and by controlling the simple D-switches with periodic (repeating) schedules. It describes scheduling algorithms to schedule traffic within the D-switches. It will hereafter be referred to as reference [7].

The patent by T. H. Szymanski, U.S. Pat. No. 11,019,038 B2, “Methods to Strengthen Cyber-Security and Privacy in a Deterministic Internet of Things”, issued May 25, 2021, is hereby incorporated by reference. It describes a deterministic forwarding-plane using D-switches with “Input Queues” (IQs), and D-switches with “Crosspoint Queues” (XQs). It describes the use of periodic schedules that indicate when traffic will be received at a D-switch, to detect cyber-attackers and thus strengthen cyber-security. It will hereafter be referred to as reference [8].

The patent by T. H. Szymanski, U.S. Pat. No. 10,237,199 B2, “Methods to Achieve Bounded Buffer Sizes and Quality of Service Guarantees in the Internet Network”, issued Jul. 7, 2020, is hereby incorporated by reference. It describes a deterministic forwarding-plane using D-switches with “Input Queues” (IQs), and D-switches with “Crosspoint Queues” (XQs). It describes the use of periodic schedules that indicate when traffic has reservations to be transmitted from a deterministic switch, to eliminate congestion, reduce buffer sizes and achieve QoS guarantees. It will hereafter be referred to as reference [9].

The patent by T. H. Szymanski, U.S. Pat. No. 10,182,021 B2, “Crossbar Switch and Recursive Scheduling”, issued Jan. 15, 2019, is hereby incorporated by reference. It describes a deterministic forwarding-plane using D-switches with “Crosspoint Queues” (XQs). It describes the use of periodic schedules that indicate when traffic has reservations to be transmitted from a D-switch, to eliminate congestion, reduce buffer sizes and achieve QoS guarantees. It describes methods to compute periodic schedules for the D-switch using XQs. It will hereafter be referred to as reference [10].

The patent by T. H. Szymanski, U.S. Pat. No. 10,129,167 B2, “Methods to Schedule Multiple Traffic Flows Through Packet-Switched Routers with Near-Minimal Queue Sizes”, issued Nov. 13, 2018, is hereby incorporated by reference. It describes the use of periodic schedules that indicate when traffic from multiple sources can be selected by a multiplexer and transmitted over a shared edge, to eliminate congestion, and reduce buffer sizes. It will hereafter be referred to as reference [11].

The patent by T. H. Szymanski, U.S. Pat. No. 9,042,380 B2, “Delay and Jitter Limited Wireless Mesh Network Scheduling”, issued Oct. 18, 2016, is hereby incorporated by reference. It describes a deterministic wireless forwarding-plane using deterministic switches using “Output Queues” (OQs). It describes the use of periodic schedules that indicate when wireless traffic can be transmitted from the deterministic switches, to minimize wireless interference, congestion, and to reduce buffer sizes. It describes methods to compute periodic collision-free schedules for multiple deterministic wireless switches operating in a wireless local area network. It will hereafter be referred to as reference [12].

The patent by T. H. Szymanski, U.S. Pat. No. 8,089,959, “Method and Apparatus to Schedule Packets through a Crossbar Switch with Delay Guarantees”, issued Jan. 3, 2012, is hereby incorporated by reference. It describes a “Recursive Fair Stochastic Matrix Decomposition” (RFSMD) algorithm to decompose a traffic rate matrix T into a periodic schedule (a sequence of permutation matrices and partial permutation matrices) with ultra-low delay and jitter. It will hereafter be referred to as reference [13].

The document by CISCO, entitled “Cisco Annual Internet Report (2018-2023),” (available online) is hereby incorporated by reference. It describes the number of DDoS attacks in the Consumer IoT. It will hereafter be referred to as reference [14].

The document by the US NIST (National Institute for Standards and Technology), “Zero Trust Architecture,” Publication SP-800-207, August 2020, available online, is hereby incorporated by reference. It describes a basic “Zero Trust Architecture.” It will hereafter be referred to as reference [15].

The document by Kerman, A., Borchert, O., Rose, S. and Tan, A., 2020, “Implementing A Zero Trust Architecture,” NIST 75, 2020, available online, is hereby incorporated by reference. It describes implementation details for a Zero Trust Architecture. It will hereafter be referred to as reference [16].

The document by ETSI (European Telecommunications Standards Institute), Technical Report, “Quantum Safe Virtual Private Networks,” ETSI TR 103 617 v1.1.1, August 2018, is hereby incorporated by reference. It describes how Quantum Safe ciphers can be added to “Virtual Private Networks” in the Consumer IoT, to achieve cryptographic security. It will hereafter be referred to as reference [17].

The document by V. Hu. D. Feraiolo, R. Kuhn, A. Schnitzer, K. Sandin, R. Miller, K, Scarfone, “Guide to Attribute Based Access Control (ABAC) Definitions and Considerations,” US NIST Publication SP 800-162, January 2014 (with updates dated August 2019), is hereby incorporated by reference. It describes a basic “Attribute Based Access Control” (ABAC) system, which can be used to implement a Zero Trust Architecture. It will hereafter be referred to as reference [18].

The document by ETSI (European Telecommunications Standards Institute), Technical Report, “Quantum Safe Public Key Encryption and Key Encapsulation,” ETSI TR 103 823, v1.1.2, October 2021, available online, is hereby incorporated by reference. It describes the several algorithms evaluated by the US NIST for Quantum Safe public key encryption, to replace classical public key encryption such as RSA. It will hereafter be referred to as reference [19].

The document by K. Scarfone, P. Mell, “Guide to Intrusion Detection and Prevention Systems (IDPS),” NIST Special Publication 800-94, February 2007, available online, is hereby incorporated by reference. It describes “Intrusion Detection Systems”, i.e., methods to try to detect cyber-attackers in the Consumer IoT. It will hereafter be referred to as reference [20].

The paper by A. K. Parekh and R. G. Gallager, entitled “A Generalized Processor Sharing Approach to Flow Control in Integrated Services Networks: The Single-Node Case” IEEE/ACM Trans. Networking, 1993, 1, pp. 344-357, is hereby incorporated by reference. It describes the well-known “Generalized Processor Sharing” algorithm for scheduling the transmissions of multiple sources onto a shared directed edge. It will hereafter be referred to as reference [21].

The paper by A. K. Parekh and R. G. Gallager, entitled “A Generalized Processor Sharing Approach to Flow Control in Integrated Services Networks: The Multiple Node Case”, IEEE/ACM Trans. Networking, 1994, 2, pp. 137-150, is hereby incorporated by reference. It describes the use of the well-known “Generalized Processor Sharing” algorithm for scheduling the transmissions of multiple sources in a network of switches. It will hereafter be referred to as reference [22].

The “Transport Layer Security” (TLS) protocol is described in the document by E. Rescorla, IETF (Internet Engineering Task Force) RFC (Request for Comments) 8446, “The Transport Layer Security (TLS) Protocol Version 1.3,” 2018, which is hereby incorporated by reference. It describes the use of ciphers to encrypt traffic in layer-4 and higher of the Consumer IoT. It will hereafter be referred to as reference [23].

The US “Advanced Encryption Standard” (AES) algorithm is described in the document by US NIST (National Institute of Standards and Technology), Federal Information Processing Standards (FIPS), Publication 197, “Announcing the Advanced Encryption Standard (AES),” Nov. 26, 2001. updated May 9, 2023, which is hereby incorporated by reference. It can encrypt blocks of data of length 128 bits, using secret keys of lengths 128, 192 and 256 bits. It will hereafter be referred to as reference [24].

The Chacha20 cipher and Poly1305 authentication algorithm are described in the document by Y. Nir and A. Langley, entitled “Chacha20 and Poly1305 for IETF Protocols,” IETF (Internet Engineering Task Force) RFC 8439, 2018, which is hereby incorporated by reference. The Chacha20 cipher can encrypt a stream of blocks, each with 512 bits, using a 256 bit secret key and a 64 or 96 bit nonce (a random number used only once with a given secret key). It will hereafter be referred to as reference [25].

The “Authenticated Encryption” algorithm proposed by the IETF is described in the document by D. McGrew, entitled “An Interface and Algorithms for Authenticated Encryption,” IETF (Internet Engineering Task Force), RFC 5116, 2008, which is hereby incorporated by reference. It uses the Chacha20 cipher and the Poly1305 authenticator to provide “authenticated encryption” in layer-4 of the Consumer IoT. It will hereafter be referred to as reference [26].

Vulnerabilities of “Quantum Key Distribution” (QKD) networks are described in the document by the US National Security Agency (NSA), “Quantum Key Distribution (QKD) and Quantum Cryptography (QC),” available online at this address, ‘nsa.gov/Cybersecurity/Quantum-Key-Distribution-QKD-and-Quantum-Cryptography-QC’, which is hereby incorporated by reference. This document shows that QKD networks cannot authenticate the sender, and they are vulnerable to DoS attacks and internal cyber-attackers. As a result, the US NSA does not recommend the use of QKD networks. It will hereafter be referred to as reference [27].

Traditional and complex SDN control-planes are described in the document by M. Dabbagh, B. Hamdaoui, M. Guizani, and A. Rayes, entitled “Software-Defined Networking Security: Pros and Cons,” IEEE Communications Magazine, June 2015, which is hereby incorporated by reference. A traditional SDN control-plane may contain 1000s of rules of how to process packet headers, and these rules are downloaded to the best-effort switches, so that switches can process packet headers to make routing decisions in layer-3. It will hereafter be referred to as reference [28].

The generation of true random numbers using a “Quantum Random Number Generator” is described in the paper by J. Y. Haw, S. M. Assad, A. M. Lance, N. H. Y. Ng, V. Sharma, P. K. Lam, and T. Symul, entitled “Maximization of extractable randomness in a quantum random-number generator”, Physical Review Applied, 2015, 3(5), p. 054004, which is hereby incorporated by reference. It will hereafter be referred to as reference [29].

### DETAILED DESCRIPTION

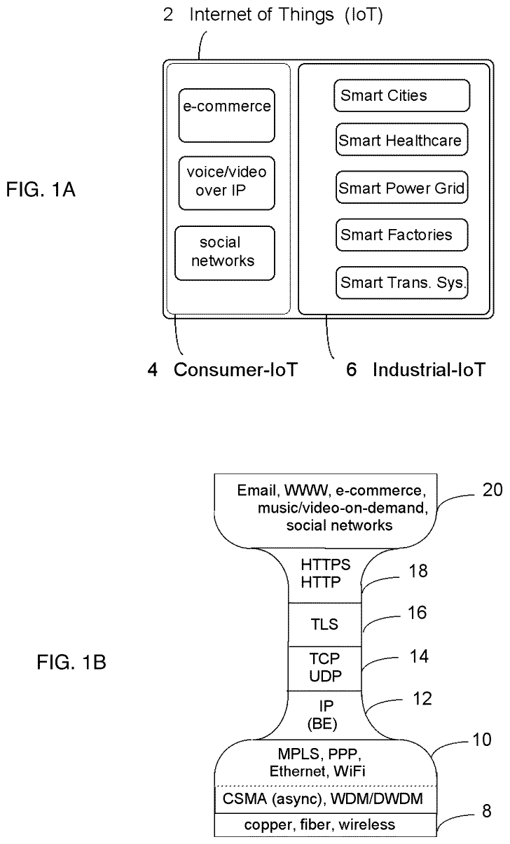

FIG. 1A illustrates a Venn-like diagram, with the next-generation IoT 2, comprising the Consumer IoT 4 and the Industrial IoT 6. The Consumer IoT 4 supports consumer applications, such as: (i) e-commerce (e.g., from companies such as Amazon and Alibaba); (ii) voice, video and music over IP (e.g., from companies such as Netflix, Amazon, Zoom, Google, Microsoft and Apple); (iii) social networks (e.g., from companies such as Facebook, LinkedIn and TikTok). Consumer applications can typically function at an acceptable level, given the Best-Effort service that the Consumer IoT 4 provides. The Consumer IoT 4 is however subject to millions of cyber-attacks per year, as explained in the document by CISCO, entitled “Cisco Annual Internet Report (2018-2023)” (reference [14], incorporated by reference earlier).

The Industrial IoT 6 supports smart Cyber-Physical Systems, such as Smart Cities, Smart Healthcare systems, Smart Power Grid, Smart Factories, and Smart Transportation Systems. These systems control critical resources, using “Machine-to-Machine” (M2M) traffic flows over the Industrial IoT 6. The failure of these control systems could cause major disruptions and loss of life. The Industrial IoT 6 should, therefore, provide deterministic (or “nearly deterministic”) QoS guarantees, where each M2M traffic flow receives service with a deterministic (guaranteed) data-rate, with very low delay and jitter and with immunity to cyber-attacks (such as DoS/DDoS attacks).

FIG. 1B illustrates the “Narrow-Waist” model for the protocol stack for the Consumer IoT 4, first proposed by Prof. Leonard Kleinrock of UCLA in 1994. This model has not changed much in 3 decades. At the bottom, layer one 8 (the physical layer) supports copper, fiber and wireless technologies. Layer two 10 (the datalink layer) supports local area networks, such MPLS (“Multi-Protocol Label Switching”) networks, networks using the “Point-to-Point” (PPP) protocol, Ethernet, and Wi-Fi wireless networks. These networks may use technologies such as “Carrier Sense Multiple Access” (CSMA), “Wavelength Division Multiplexing” (WDM), and “Dense WDM” (DWDM). Layer three 12 (the networking or IP layer) supports the Internet Protocol (IP). All traffic in the Consumer IoT 4 must pass through IP, leading to the “narrow waist” concept. IP provides only a “Best-Effort” (BE) service. Layer four 14 (the transport layer) supports the “Transmission Control Protocol” (TCP) and the “User Datagram Protocol (UDP).

The “Transport Layer Security” (TLS) protocol 16 is assumed to operate in layers four to seven. TLS provides confidentiality to traffic flows in the Consumer IoT 4. It authenticates the sender (verifies its identify), it encrypts the data at the sender, it decrypts the data at the destination, and it verifies that the data has not been altered during transmission through the Consumer IoT 4. TLS is described in the document by Rescorla entitled “The Transport Layer Security (TLS) Protocol Version 1.3” (reference [23]). “Hyper-Text-Transfer-Protocol” (HTTP) 18 operates above TLS 16. It allows users to connect to web-servers. The “HTTP-over-TLS” protocol (HTTPS) 18 also operates above TLS 16. It allows users to connect to web-servers, using encrypted and authenticated channels. At the top of FIG. 1B, in layer seven 20, the consumer applications reside. These applications include email, the world-wide-web (WWW), e-commerce, voice/video/music-over-IP, and social networks such as Facebook, LinkedIn, and TikTok.

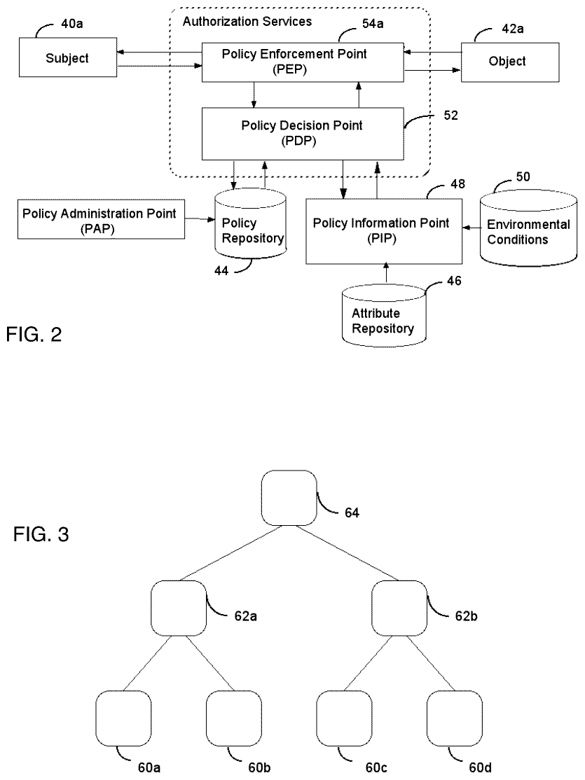

FIG. 2 illustrates an “Attribute Based Access Control” (ABAC) system, a rule-based system which can control access to resources. An ABAC system is described in the document by Hu et al., entitled “Guide to Attribute Based Access Control (ABAC) Definitions and Considerations” (reference incorporated by reference earlier). It comprises a set of subjects 40 and a set of objects 42. One subject 40a and one object 42a are shown in FIG. 2. Each object 42 has many “attributes” associated with it. Attributes are properties that describe the object in detail. Consider an object defining a “record.” An attribute can be viewed as any data that further defines the object, e.g., an attribute may specify the type of record (medical record, bank record), the security level (none, classified, top-secret), the department to which it belongs (engineering, finance), or its location. The ABAC system comprises a “Policy Repository” 44, to store rules and facts. Rules have the form “if (events occur) then (the consequences of said events).” It has an “Attribute Repository” 46 to store the attributes associated with objects. It has a “Policy Information Point” 48, which combines knowledge from the Attribute Repository 46 and the current environmental conditions 50. A decision is made by the “Policy Decision Point” module 52, which receives information from the Policy Information Point 48. The Policy Decision Point module 52 is essentially a logical “inference engine” that evaluates the rules and environmental conditions and makes access decisions. The access of a subject 40 to an object 42 is controlled by a hardware “Policy Enforcement Point” (PEP) 54.

Implementing such a system involves: (i) implementing the entire ABAC system; (ii) implementing a number of rules to control access; and (iii) implementing a number of Policy Enforcement Points (PEPs) 54 in hardware, to enforce the policy decisions (i.e., control access to resources). It is difficult (if not impossible) to add such a control system retroactively, to a large system such as the Consumer IoT 4, since it might involve adding billions of PEPs 54 to the Consumer IoT 4 retroactively. The collection of rules and facts needed to control access to resources is called the “knowledge-base.” The knowledge-base of an ABAC system comprises the set of facts and rules needed to control a given system. A knowledge-base can contain 1000s of rules, to control access to resources.

A “Zero Trust Architecture” is a type of control system, in which any request by a subject to access an object, is subject to authentication of the requestor. In the older “perimeter-based” security model, a user is authenticated once when it enters a “trusted zone” and, thereafter, it can access the resources within the trusted zone, without further authentication. This perimeter-based security model may be shown to be vulnerable to cyber-attacks, in which an attacker with a stolen password can access a trusted zone and, thereby, access all resources within the trusted zone. To combat this scenario, the “Zero Trust Architecture” (ZTA) has emerged. A ZTA is essentially an ABAC system, in which a user requesting access to any resource, however small, is subject to user authentication. The concept of a “trusted zone” in which users can freely access resources no longer exists. Zero Trust Architectures are described in the document “Zero Trust Architecture” and the document “Implementing A Zero Trust Architecture” (references and incorporated by reference earlier).

FIG. 3 illustrates an AC/AC control system 19 proposed in this disclosure, which comprises 3 layers of collaborating rule-based ZTA controllers. These ZTA controllers are ABAC controllers, in which rules exist to require user authentication, for access requests to any resource. The bottom layer includes Enterprise-Controllers 60. Each Enterprise-Controller 60 contains the “knowledge-base” needed for one enterprise (i.e., one company) to control access to its own resources. In FIG. 3, the middle layer includes WAN-controllers 62. Forwarding-plane 94 is equivalent to the SDD-WAN 94. (The terms “forwarding-plane” 94 and “SDD-WAN” 94 will be used interchangeably.) The Industrial IoT 6 may comprise several distinct SDD-WANs 94, each owned and managed by an independent service-provider, such as Google, Amazon Web Services, Microsoft, Apple, etc. Each of these service-providers may implement a WAN-Controller 62, to manage access to its resources available over its own SDD-WAN 94. Resources within an SDD-WAN 94 could include: (i) data-centers for cloud computing applications; (ii) data-bases, e.g., a data-base of medical information for millions of patients; and (iii) specialized software. This disclosure proposes a new and unique resource to be controlled, access to the bandwidth of a layer-3 forwarding-plane 94 (the SDD-WAN 94). Specifically, the AC/AC control system 19 is expected to control access, to determine which devices can transmit data over the SDD-WAN 94. Hence, each service-provider will require an extensive Knowledge-Base of rules to control access to the resources available over its own SDD-WAN 94.

Suppose Alice and Bob are employees of enterprise #1 60a. A rule to control Alice's access to a computer #7 can be stated (in plain English) as follows:

IF (subject X requests access to computer-#7) AND (subject X enters the user-ID “alice@enterprise1.com”) AND (subject X enters a password which matches Alice's password in the knowledge-base) AND (subject X's facial image matches Alice's facial image in the knowledge-base) AND (subject X successfully enters a passcode that was sent to Alice's cell phone for dual factor authentication) AND (Alice has permission to access computer-#7 in the knowledge-base) THEN (Subject X is Alice and Alice has just been authenticated) AND (Alice is granted permission to access computer-#7, for 2 hours).

A key goal of QKD networks, since their inception in 1984, is to establish “cryptographic security” (i.e., protection from eavesdroppers) between two communicating parties (typically called “Alice” and “Bob”), in the presence of a potential eavesdropper with a powerful computer (typically called “Eve”). According to one aspect of this disclosure, two entities can establish a Quantum Safe AEDC between themselves by requesting an AEDC from the AC/AC control system 19. For example, a rule to control whether or not Alice can establish an AEDC to a remote computer can be stated as follows (the “knowledge-base” will refer to the knowledge-base of enterprise #1):

IF (Alice is working at computer-#7) AND (Alice requests an AEDC to computer-#9) AND (Alice successfully enters a passcode that was just sent to Alice's cell phone for dual factor authentication) AND (the facial image on computer-7's camera matches Alice's facial image in the knowledge-base) AND (Alice has permission to establish an AEDC from computer-#7 to computer-#9 in the knowledge-base) AND (computers #7 and #9 each have permission to be connected to one another with an AEDC in the knowledge-base) THEN (Alice's request to establish an AEDC between computers #7 and #9, for 2 hours, is granted).

The previous rule did not request a specific deterministic rate for the AEDC, or bounds on the delay, jitter or reliability. These requirements can easily be added to the rule above. In general, a knowledge-base can contain 1,000s of rules, established over time, to control access to all resources and to detect the attempted unauthorized use of resources.

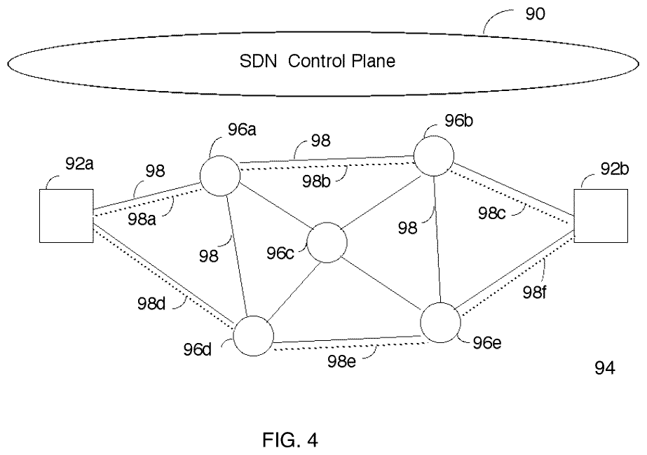

FIG. 4 illustrates a proposed SDN control-plane 90 and the proposed forwarding-plane 94. The forwarding-plane 94 includes many “deterministic transceivers” (D-transceivers) 92, and many simple “deterministic packet switches” 96. The complex tasks of routing and scheduling of traffic in layer-3 has been removed from the D-switches 96 and migrated into the SDN control-plane 90. In FIG. 4, many D-switches 96 are interconnected with directed edges 98, to form the low-complexity deterministic forwarding-plane 94. A directed edge 98 typically transmits packets over a fiber-optic transmission line. (Electrical links and directed wireless links can also be used in the proposed forwarding-plane 94. The use of fiber-optic transmission lines is not essential.) The forwarding-plane 94 may support many end-to-end D-flows 22, each departing from a source node (D-transceiver 92a) and arriving at a destination node (D-transceiver 92b). In the Consumer IoT 4, the path taken by a best-effort traffic flow from a source node to a destination node may change frequently, due to the use of middle-boxes which perform load-balancing (not shown in FIG. 4). In contrast, in the proposed low-complexity forwarding-plane 94, a D-flow 22 will follow a fixed path from the source node (D-transceiver 92a) to the destination node (D-transceiver 92b). The edges 98a, 98b and 98c illustrate one fixed path from the source node 92a to the destination node 92b. The edges 98d, 98c and 98f illustrate a second fixed path from the source node 92a to the destination node 92b. In the forwarding-plane 94, the traffic from a source node 92a to a destination node 92b can also be duplicated and transmitted over a several fixed paths, in parallel, to increase reliability and provide protection from the failure of any one path.

Software Defined Networking (SDN) refers to use of a type of network wherein a logical control-plane 90 (also called an SDN control-plane 90) exists, to control a network. In FIG. 4, the SDN control-plane 90 can control each D-switch 96 in the forwarding-plane 94, by sending encrypted control packets over the forwarding-plane 94 to each D-switch 96 with control commands. The SDN control-plane 90 can exist as a single software entity residing at one location (or one data-center), or it can be distributed over multiple locations (or multiple data-centers). For maximum reliability, the SDN control-plane 90 should execute in multiple data-centers at multiple locations, and majority voting should be used to consolidate the results. For example, three copies of the SDN control-plane 90 can execute in three different data-centers, and majority voting is used to confirm every decision made by the control-plane 90. The SDN control-plane 90 will send encrypted control packets into the forwarding-plane 94, to control each D-switch 96 and each D-transceiver 92. The SDN control-plane 90 can configure it own “Deterministic Virtual Private Network” (D-VPN) to control the D-switches 96 and D-transceivers 92. A D-VPN is a collection of AEDCs (D-flows) organized into a single “virtual private network”, typically under the control of one enterprise, wherein all AEDCs use Quantum Safe ciphers. Hence, the SDN control-plane 90 can communicate with the D-switches 96 and D-transceivers 92 over a dedicated D-VPN. The communications within a D-VPN are encrypted with Quantum Safe ciphers, using secret keys with at least 256 bits, to provide immunity to cyber-attacks from quantum computers.

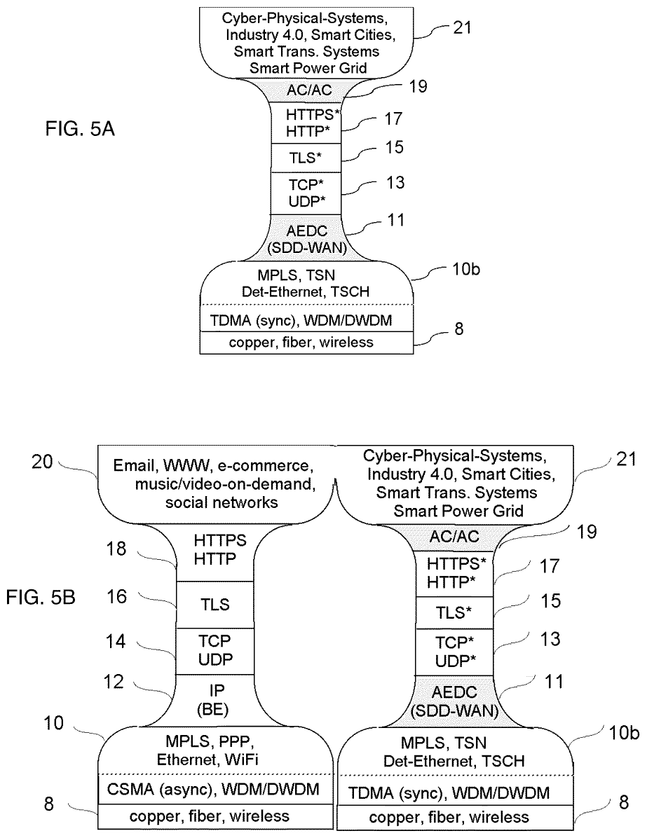

FIG. 5A illustrates the protocol stack for an Industrial IoT 6, when using the proposed AC/AC control system 19. At the bottom, layer one 8 (the physical layer) supports copper, fiber and wireless technologies. Layer two 10b (the datalink layer) supports local area networks, such MPLS, “Time Sensitive Network” (TSN) technologies developed by the IEEE, the Deterministic Ethernet technology developed by the IEEE, and deterministic wireless networks developed by the IEEE, using the “Time Synchronized Channel Hopping” (TSCH) technology. These networks may use technologies such as “Time Division Multiple Access” (TDMA), “Wavelength Division Multiplexing” (WDM), and “Dense WDM” (DWDM). TDMA allows for the scheduling of transmissions over a medium in advance, so that transmissions occur according to a predetermined schedule. Layer three 11 (the networking layer) of the Industrial IoT 6 abandons the use of IP, with all its vulnerabilities. In contrast, layer three 11 will implement “Authenticated Encrypted Deterministic Channels” (AEDCs 22), directly in hardware, in the proposed forwarding-plane 94, which is also called a “Software-Defined-Deterministic WAN” (SDD-WAN 94). AEDCs 22 are also called “deterministic traffic flows” (D-flows 22). The AEDCs 22 do not use the IP protocol, and thus eliminate all the vulnerabilities of IP that have existed in layer three of the Consumer IoT 4 for several decades, i.e., the use of: (i) unencrypted IP packet headers; (ii) unauthenticated IP packet headers; (iii) insecure layer-3 middle-boxes; (iv) insecure layer-3 routing algorithms; and (v) insecure Domain Name Servers (DNSs). It will be shown that the end-to-end delays over an AEDC 22 are reduced to “ultra-low-latencies”, determined by the speed of light in fiber. It will be shown that the AEDCs 22 are also immune from external cyber-attackers with Quantum Computers, under realistic conditions (which will be described ahead).

In FIG. 5A, layer four 13 includes the protocols TCP* and UDP*, deterministic versions of the protocols TCP and UDP used in the Consumer IoT 4. TLS* is a deterministic version of the TLS protocol which exists in the Consumer IoT 4. It typically resides in layer 4. HTTPS* and HTTP* are deterministic versions of the protocols HTTPS and HTTP which reside in the Consumer IoT 4.

As shown in FIG. 1B, the Consumer IoT 4 has many consumer applications in the top layer 20, such as email and e-commerce. In FIG. 5A, the Industrial IoT 6 has many applications for smart Cyber-Physical Systems and Industry 4 in the top layer 21. In FIG. 5A, the AC/AC control-system 19 is inserted just below the top layer 21. Any Industrial application wishing to communicate over the Industrial IoT 6 must first request permission from the AC/AC control system 19 to create an AEDC 22 in the forwarding-plane 94. The SDN control-plane 90 will precompute data for the requested AEDC 22, i.e., whether or not the requested data-rate can be achieved, and whether or not the requested bounds on the delay, jitter or reliability can be achieved. The AC/AC control system 19 will access its knowledge base and render an access decision. If the request to create an AEDC 22 is approved, the SDN control-plane 90 (not shown in FIG. 5A) will precompute additional data needed to establish the AEDC 22, and it will download this precomputed data to configure the AEDC 22 in the forwarding-plane 94. Data that is precomputed in the SDN control-plane 90 may include: (i) the routing information; (ii) the scheduling information; (iii) secret keys used to authenticate, encrypt and decrypt the data being transmitted; and (iv) data used in “Flow-Tables” (which will be explained ahead). This information is downloaded from the SDN control-plane 90, to the D-switches 96 and the D-transceivers 92 in the forwarding-plane 94, to enable the creation of the new AEDC 22. How this data is precomputed will be explained ahead. This general architecture has been described in the paper by T. H. Szymanski, entitled “The “Cyber-Security via Determinism” Paradigm in a Quantum Safe Zero Trust Deterministic Internet of Things”, (reference [1]).

Consider a request to establish a set of AEDCs 22 in the forwarding-plane 94. If the AC/AC control system 19 approves the request, the SDN control-plane will precompute the routing, scheduling and secret keys to be used by the requested set of AEDCs 22. A flow-chart used by the SDN control-plane to precompute these values will be described ahead in detail. To perform the scheduling of these new AEDCs 22, the SDN control-plane 90 will precompute a TDMA schedule, for every directed edge 98 in the forwarding-plane 94 that the new AEDCs 22 will traverse. The transmissions in every directed edge 98 are deterministic, and are governed by a periodic (i.e., repeating) scheduling-frame, containing F time-slots for integer F. The precomputed TDMA schedule for a given directed edge 98 will determine which time-slots in said schedule have reservations to transmit data, for any AEDCs 22 that traverse that directed edge 98. Any data transmitted at any other time-slots is an “anomaly”, i.e., a cyber-attack. Hence, according to one aspect of this disclosure, the use of the AC/AC control system 19 and TDMA schedules for directed edges 98 provides a means to control access to the bandwidth of the forwarding-plane 94, and a means to detect cyber-attackers. The use of deterministic schedules allows for a “Guaranteed Intrusion Detection System” in layer-3. Traditional methods to detect cyber-attacks in the Consumer IoT 4 are described in the document “Guide to Intrusion Detection and Prevention Systems (IDPS)”, (reference [20]).

The SDN control-plane 90 will also determine the secret keys to be used to encrypt/decrypt and authenticate each AEDC 22 in layer-3. (Typically, two secret keys are used, one for encryption/decryption and another for authentication.) The use of the US “Advanced Encryption Standard” (AES) cipher, with secret key of 256 bits, is considered to be “Quantum Safe”, i.e., even a quantum computer cannot crack the AES cipher with a 256 bit key, using known quantum algorithms. The AES cipher is described in the document “Announcing the Advanced Encryption Standard (AES)”, (reference [24]). The Chacha20 cipher and the Poly1305 authentication algorithm have been adopted by the IETF and are also considered to be Quantum Safe. The Chacha20 cipher and the Poly1305 authenticator, traditionally used in the TLS protocol which typically resides in layer-4, are described in the document “Chacha20 and Poly1305 for IETF Protocols”, (reference [25]).

If a request for a new AEDC(s) 22 is approved by the AC/AC control system 19, the SDN control-plane 90 will download all the precomputed information to the relevant D-switches 96 and D-transceivers 92 in the forwarding-plane 94, to enable the new AEDC(s) 22 to be established in layer-3.

Referring to FIG. 1B, a consumer application in the top layer 20 of Consumer IoT 4 will invoke the following protocols to communicate over the Consumer IoT 4: (i) HTTP or HTTPS 18; (ii) TLS 16; (iii) TCP or UDP 14; and then (iv) IP 12. Referring to FIG. 5A, an industrial application in the top layer 21 of the Industrial IoT 6 will invoke the following protocols to communicate over the forwarding-plane 94, if it receives permission from the AC/AC control system 19 to establish an AEDC 22 in the forwarding-plane 94: (i) HTTP* or HTTPS* 17, (ii) TLS* 15; and (iii) TCP* or UDP* 13. It can then send data over the AEDC 22 (and thereby avoid the use of IP in layer-3).

In FIG. 5A, the protocols HTTP* or HTTPS* 17 of the Industrial IoT 6 are similar to the protocols HPPT or HTTPS 18 of the Consumer IoT 4 shown in FIG. 1B, except for two main differences: (1) HTTP* or HHTPS* 17 can only be invoked by an industrial application in the top layer 21 if approval from the AC/AC control system 19 is received in advance; and (2) HTTP* or HTTPS* 17 receive deterministic service with strict QoS guarantees, where the data is guaranteed to be delivered with probabilistic guarantees, i.e., the probability that a packet is delivered can be designed to be a very close to 1.0. (Data can be transmitted over multiple paths, to achieve very high reliability.)

In FIG. 5A, the protocol TLS* 15 of the Industrial IoT 6 is similar to the protocol TLS 16 of the Consumer IoT 4 shown in FIG. 1B, except for the following 2 main differences: (1) TLS* 15 can only be invoked by an industrial application in the top layer 21 if approval from the AC/AC control system 19 is received in advance; and (2) TLS* receives deterministic service with strict QoS guarantees, i.e., the probability that a packet is delivered can be designed to be a very close to 1.0.

In FIG. 5A, the protocols TCP* or UDP* 13 of the Industrial IoT 6 are similar to the protocols TCP or UDP 12 of the Consumer IoT 4 shown in FIG. 1B, except for the following 2 main differences: (1) TCP* or UDP* 13 can only be invoked by an industrial application in the top layer 21 if approval from the AC/AC control system 19 is received in advance; and (2) TCP* or UDP* 13 receive deterministic service with strict QoS guarantees, i.e., the probability that a packet is delivered can be designed to be a very close to 1.0. Hence, these protocols can be simplified, as explained next.

Consider the TCP protocol 14 in the Consumer IoT 4 shown in FIG. 1B. TCP 14 can send a plurality of packets to a destination in the Consumer IoT 4. It typically maintains a sliding “window” of unacknowledged packets. It typically waits for the acknowledgement of each packet sent. For each packet successfully acknowledged, it removes that packet from the “tail” of sliding window, and it can transmit another new packet to the destination, which is added to the “head” of sliding window. Each packet has a sequence number, and TCP 14 ensures that packets are delivered without bit errors and in the correct sequence. If the destination does not receive the packet it expects, it sends an error message to the sender, using TCP 14. This feedback enables TCP 14 to re-send the missing packet. This process of using the TCP protocol 14 to detect an unacknowledged packet, requesting its retransmission, and performing the actual retransmission of the packet, can take several 100s of milliseconds, or even several seconds. Hence, TCP 14 cannot provide deterministic QoS guarantees on the delay or jitter of a packet, in the Consumer IoT 4.

In FIG. 5A, consider the TCP* protocol 13 in the Industrial IoT 4. TCP* 13 can send R redundant copies of each packet, from a source node 92a to a destination node 92b, over R “edge-disjoint” paths, simultaneously. R represents the “redundancy”. Edge-disjoint paths do not share any edges. The destination will receive at least one copy of the packet, unless all R edge-disjoint paths fail simultaneously. The proposed SDN control-plane 90 can monitor the quality of transmissions over every directed edge 98, (i.e., an optical transmission line), and pre-emptively signal administrators to replace a directed edge 98 whose transmission quality drops. For example, a D-transceiver 92 which receives data from a directed edge 98 will be able to gather statistics on the packet error rate (i.e., the fraction of packets that are received with bit errors), and convey this information to the SDN control-plane 90. The proposed SDN control-plane 90 can also pre-emptively avoid using directed edges 98 whose transmission quality drops. With these precautions, the probability that any directed edge 98 in the forwarding-plane 94 fails can be made very small, i.e., ideally less that 1 hour of failure per year of operation. The probability that all R edge-disjoint paths fail simultaneously can be made arbitrarily small, by increasing the redundancy factor R. Each edge-disjoint path transmits its data with ultra-low latency, so the destination will receive at least one copy of the packet, with exceptionally low delays, provided that at least one of the R redundant paths is operational. Hence, a new protocol TCP* 13 must be programmed into the computer operating systems, such as Linux, Windows, and the MAC OS, to enable communications over the Industrial IoT 6.

To summarize, in FIG. 5A the protocols HTTP* or HTTPS* 17, TLS* 15, and TCP* or UDP* 13 which are used in the proposed Industrial IoT 6 should be programmed into operating systems, such as Linux, Unix, Microsoft Windows or Apple MAC-OS, so that they are available to industrial applications in the top layer 21 of the Industrial IoT 6.

FIG. 5B illustrates a proposed “Dual Pillar” protocol stack for the next-generation IoT, which supports the existing Consumer IoT 4 and the proposed new Industrial IoT 6. Consumer applications at the top layer 20 of the Consumer IoT 4 will traverse the left protocol stack, called the “Best-Effort” pillar, and receive “Best-Effort” service with no deterministic QoS guarantees. The Consumer IoT 4 is subject to excessive delays, congestion, BufferBloat, and a large number of cyber-attacks. Industrial applications at the top layer 21 of the Industrial IoT 6 will traverse the right protocol stack, called the “Deterministic” pillar, and receive “deterministic” service for each AEDC 22, with strict QoS guarantees. The AEDCs 22 receive service with ultra-low latency, with probabilistic bounds: (i) on the probability that a packet will be delivered by a given deadline; (ii) the allowable jitter a packet can receive; and (iii) the reliability. As a result of the AC/AC control system 19, the AEDCs 22 are also immune to external cyber-attacks, i.e., the probability of a successful external cyber-attack can be made arbitrarily small. As a result of the AC/AC control system 19, the AEDCs 22 are also strongly immune to internal cyber-attacks, i.e., the probability of a successful internal cyber-attack can be made very small, by creating more intricate rules to control access to resources.

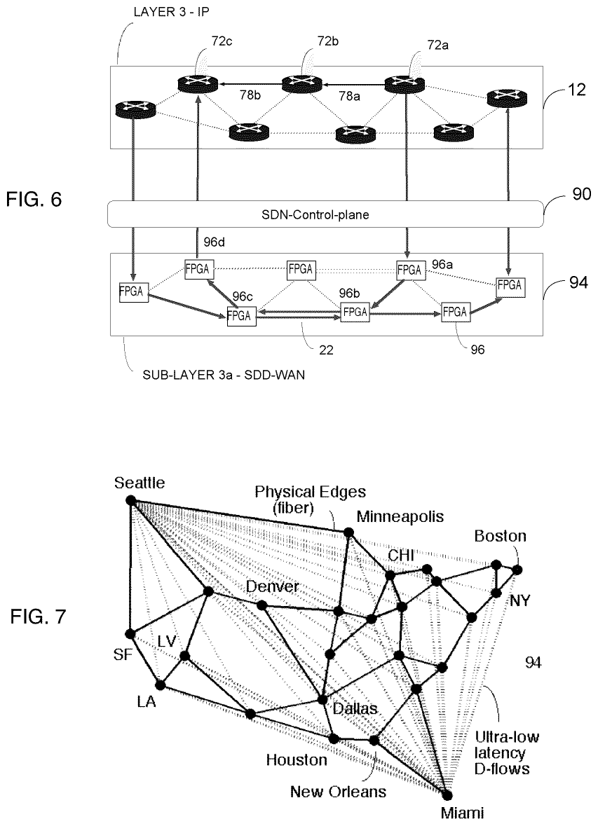

FIG. 6 illustrates the hardware needed in the network layer 12 (layer three), to support the Consumer IoT 4 and the Industrial IoT 6. The top of FIG. 6 illustrates the traditional layer-three 12 of the Consumer IoT 4. It comprises several IP-routers 72. The traditional layer three 12 delivers several “Best-Effort traffic flows” (BE-flows 78), each departing from a sending IP-router 72, and arriving at a destination IP-router 72. A BE-traffic flow 78 is shown departing from the IP-router 72a, traversing IP-router 72b, and arriving at its destination at IP-router 72c. This BE-flow traverses 2 directed edges in layer three 12, 78a and 78b.

FIG. 6 also illustrates the new forwarding-plane 94 described in this disclosure. The forwarding-plane 94 resides in a new “sub-layer” called sub-layer-3a, just below layer three 12. In FIG. 6, each IP-router 72 in layer three 12 has a corresponding low-complexity D-switch 96 in the forwarding-plane 94 in sub-layer-3a. (The one-to-one correspondence is not necessary.) A D-switch 96 is much simpler than an IP-router 72. IP-routers must contain buffers for 10s of millions of packets, to mitigate congestion. Buffer sizes in IP-routers can be estimated using a “Bandwidth-Distance Product” (BDP) rule of thumb. An IP-router 72 with a capacity of 4 terabits per second (Tbps) and an end-to-end delay of 250 milliseconds (which are reasonable values for the Consumer IoT 4), will typically require memory for about 1 terabit of data, to mitigate congestion. This amount of memory far exceeds what can be realized on a single Integrated Circuit. Hence, an IP-router 72 typically requires 10s of integrated circuits, packaged into multiple printed circuit boards, which are contained in an “electronic cabinet”. Each IP-router 72 must perform the complex layer-three routing algorithms and scheduling algorithms. Hence, each IP-router 72 in layer-three 12 requires an operating system, with several gigabytes of memory, to hold software to perform relatively complex routing and scheduling algorithms. IP-routers 72 use lookup tables to route packets, which require several Gigabytes of high-speed random-access-memory (RAM). The use of an operating system, software using many gigabytes of RAM, lookup tables using many gigabytes or RAM, all severely lower the security and reliability of an IP-router 72, and increase its costs.

A D-switch 96 is much simpler than an IP-router 72. All the complex tasks for the routing and scheduling of packets have been precomputed and performed in the SDN control-plane 90. The SDN control-plane 90 downloads precomputed data, to configure each D-switch 96. It is shown later in this disclosure that the amount of buffering in a D-switch 96 can be reduced by a factor of 100,000-1,000,000 times, relative to an IP-router 72. A D-switch 96 will typically buffer a few hundred packets, rather than 10s of millions of packets. Hence, a simple D-switch 96 can fit onto a single integrated circuit, either an “Application Specific Integrated Circuit” (ASIC), or a “Field Programmable Gate Array” (FPGA), which will lead to a substantial reduction in the cost of implementing a forward-plane 94. References [1] and [2] estimate the cost savings at $10s . . . $100s of billions USD per year, respectively.

FIG. 6 also illustrates how IP-routers 72 in layer-three 12 of the Consumer IoT 4 can use AEDCs 22 (D-flows 22), to improve performance and security. The IP-router 72a has a D-transceiver (not shown in FIG. 6), which allows it to send deterministic packets to a D-switch 96a in sub-layer-3a. That data will traverse a path of D-switches 96a, 96b, 96c and 96d, and then that data will be forwarded back up to layer three (using a D-transceiver which is not shown in FIG. 6) and received at a receiving IP-router 72c. In this manner, the forwarding-plane 94 in sub-layer-3a of the Industrial IoT 6 has been used interconnect IP-routers 72 in layer-three 12 of the Consumer IoT 4, using ultra-low latency D-flows 22, with strong immunity to external cyber-attacks. If IP-router 72a has a large amount of data to send to IP-router 72c, it can bypass layer-three 12 of the Consumer IoT 4, and transmit this data over the new forwarding-plane 94 in sub-layer-3a. This ability to migrate traffic, from an inefficient IP-network in layer-three 12, to a highly efficient forwarding-plane 94 in sub-layer-3a, can save significant sums of money, estimated at $10s . . . $100s of billions USD in references [1] and [2]. The savings are a result of reduced capital and operational costs.

FIG. 7 illustrates a forwarding-plane 94 for the USA topology. Each city has a deterministic packet switch (D-switch 96). The D-switches 96 are interconnected by directed edges 98 (bold lines), which represent fiber-optic transmission lines. Several D-flows 22 are illustrated with the dotted lines. The city Seattle has an ultra-low latency D-flow 22 to every other city. The city Miami has an ultra-low latency D-flow to every other city.

A “Deterministic Virtual Private Network” (D-VPN) consists of a collection of D-flows 22, that use Quantum Safe encryption, and that are managed by a single enterprise. The D-flows 22 that connect Seattle to every other city can be organized as one D-VPN. The D-flows 22 that connect Miami to every other city can be organized as a second D-VPN. D-VPNs are managed by the SDN control-plane 90 (not shown in FIG. 7).

In accordance with one aspect of this disclosure, the proposed SDN control-plane 90 can create tens of thousands of D-VPNs in the proposed forwarding-plane 94, operating in sub-layer-3a. In accordance with another aspect of this disclosure, each D-VPN can interconnect IP-routers that operate in layer 3 and that belong to one enterprise. The D-VPNs provide ultra-low latency communications, and achieve comparable cryptographic security to QKD networks, where the security is determined by the computational hardness of cracking symmetric key cryptography. The D-VPNs are also immune to DoS attacks and DDoS attacks, while QKD networks are vulnerable to DoS attacks and internal cyber-attacks, according to the US National Security Agency, as described in reference [27].

In accordance with another aspect of this disclosure, the proposed SDN control-plane can embed many D-VPNs into a deterministic forwarding-plane 94 operating in a local area (i.e., a layer 2 network), between simple deterministic packet switches, such as wireless packet switches. A deterministic forwarding-plane 94 using wireless directed edges can be deployed. A deterministic wireless forwarding-plane, without the proposed AC/AC controller 19, was proposed in the US patent by T. H. Szymanski, “Delay and Jitter Limited Wireless Mesh Network Scheduling”, (reference [12]). The proposed AC/AC control system 19 can be added to the deterministic wireless forwarding-plane described in reference [12], to achieve much stronger cyber-security. In this case, the AC/C system 19 will control access to the bandwidth of the deterministic wireless forwarding-plane. The wireless transmissions on directed wireless edges (using directional antenna) will use encryption, as a means to eliminate external cyber-attacks and strengthen cyber-security.

### Flow-Labels

A “best-effort” traffic flow in today's Consumer IoT 4 is typically identified by examining 5 fields in the IPv4 packet header: a source IP address (32 bits) and port number (16 bits), a destination IP address and port number, and a protocol identifier (8 bits). Each traffic-flow can be identified by extracting these 5 fields from an IPv4 packet header. The 5 fields can occupy 104 bits in an IPv4 network. (An IPv6 packet uses 128 bits to identify an IPv6 address.)

“Flow-labels” are often used in many networks to simplify the process to identify a traffic flow. A “flow-label” typically comprises 20 to 24 bits, which can be inserted into a packet header, to identify the traffic flow with less processing. A flow-label with 24 bits can identify 16 million different traffic flows.

“Label-swapping” is a technique used to increase the number of traffic flows which can be identified in a network. In this scheme, each traffic flow is assigned a unique flow-label for every directed edge 98 that it traverses. IPv6 uses label-swapping. At each IPv6 router, an incoming IP packet has an incoming flow-label, and the outgoing IP packet has an outgoing flow-label, and these may differ. The IPv6 router will read the incoming flow-label of each incoming packet. The IPv6-router maintains a “flow-table”. Every traffic flow traversing the router is associated with a row of data in the flow-table. The row of data associated with the incoming flow-label will contain the outgoing flow-label and other information. The IPv6 router will determine the outgoing flow-label for the outgoing IPv6 packet, using the flow-table, and insert the outgoing flow-label into the outgoing IPv6 packet. In this manner, the entire IPv6 network can support billions of Best-Effort traffic flows which can be uniquely identified, while only using 20 or 24 bit flow-labels.

The proposed D-switches 96 can also operate using flow-labels, flow-tables and label-swapping. Label-swapping is also used in MPLS (“Multi-Protocol Label Switching”) networks. In accordance with one aspect of this disclosure, the use of flow-labels allows for the use of prioritized traffic classes in the deterministic forwarding-plane 94, as will be explained ahead.

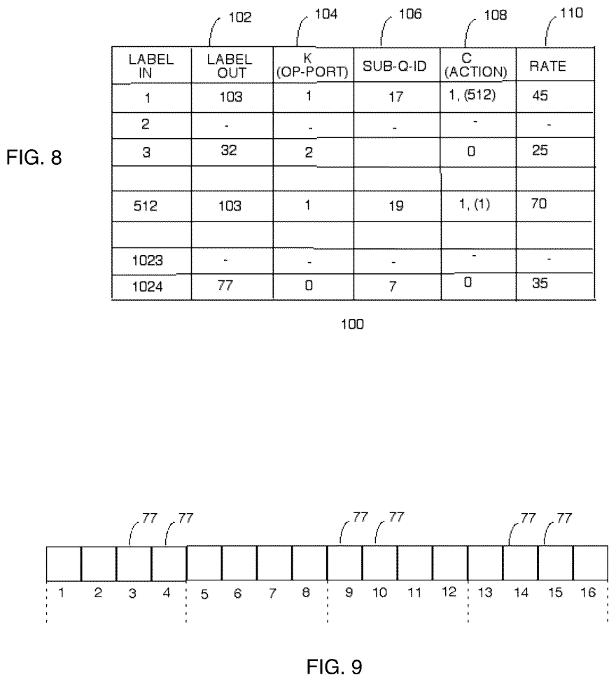

FIG. 8 illustrates a flow-table 100. Each D-flow 22 traversing a D-switch 96 is associated with one row of data in the flow-table 100. This row of data may contain the incoming flow-label. Alternatively, the incoming flow-label can be used to select one row in the flow-table 100. When a packet arrives at a D-switch 96, its incoming flow-label is extracted and used to identify the row of data associated with the D-flow 22 to which it belongs. The row of data will typically contain: (i) an outgoing flow-label 102, to be used in the packets from said D-flow 22 departing from said D-switch 96; (ii) an integer k 104 denoting the output port(k) 340 over which departing packets for said D-flow 22 must depart; (iii) a “sub-queue-identifier” 106 which can comprise approx. 2 bytes; (iv) an integer C 108 that specifies an action for the D-switch 96 to perform, along with an incoming flow-label(s); (v) a deterministic data-rate requirement 110 associated with the D-flow 22.

The integer C 108 specifies several actions the D-switch 96 can perform. C=0 implies no special action, where C=1 implies that two (or more) D-flows 22 are to be combined (or aggregated), and C=2 implies that a D-flow 22 is to be segregated into 2 (or more) D-flows 22. In the flow-table 100 shown in FIG. 8, the incoming D-flow 22 with flow-label 1 is combined with the incoming D-flow 22 with flow-label 512, and both are assigned a new outgoing flow-label with the value 103 on output port 1.

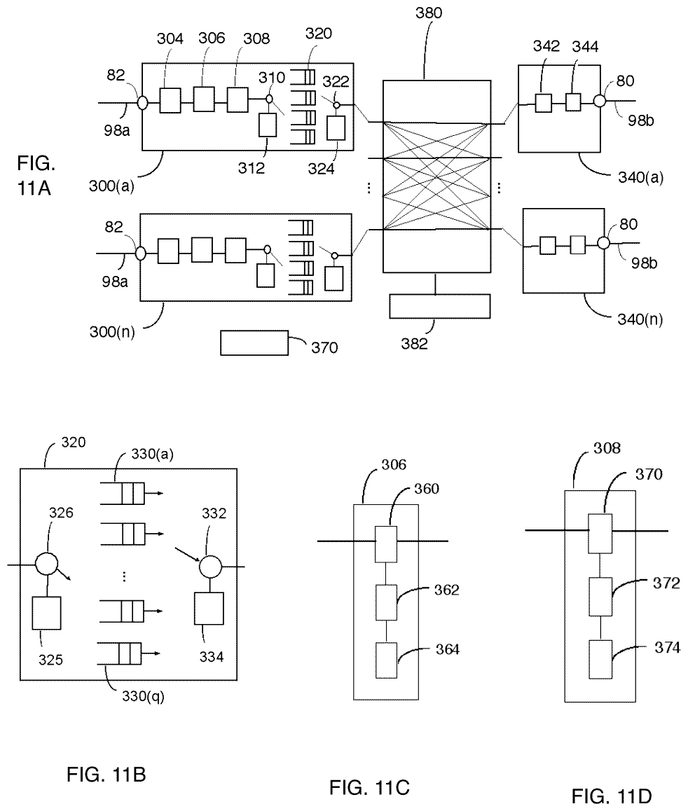

The sub-queue-identifier identifies a sub-queue 330 within a VOQ 320. Each VOQ 320 in a D-switch 96 is partitioned into multiple smaller “sub-queues” 330, as will be explained ahead in FIG. 11B, under the control of the SDN control-plane 90. A sub-queue 330 may buffer data for one D-flow 22, or it may buffer data associated with several D-flows 22. The SDN control-plane 90 controls which D-flows 22 are buffered in which sub-queues 330, in each D-switch 96, as will be explained ahead.

One advantage of using flow-labels is that multiple D-flows 22 can be combined or aggregated, into a single D-flow 22 at one D-switch 96 before transmission. When 2 (or more) flows are combined in a D-switch 96, a new flow-label is added to each packet of the combined D-flow 22. Thus, packets will have a “stack” of flow-labels, where the depth of the stack depends upon how many times they have been aggregated. The aggregated D-flow 22 can be segregated (or split back) into the constituent D-flows 22 at another D-switch 96. When a D-flow is segregated in a D-switch 96, one flow-label is removed from the stack, so each packet has the label (and label-stack) that it had before the aggregation process. In this manner, D-flows 22 can be aggregated before transmission over longer distances. For example, referring to FIG. 7, many lower rate D-flows 22 which originate at New York city and which are to be delivered at Los Angeles in the USA, can be combined into one aggregated D-flow 22 in New York city, transmitted as one higher-rate D-flow 22 over the forwarding-plane 94 to Los Angeles, and they can be segregated at Los Angeles. The use of flow-labels can reduce the complexity of the proposed D-switches 96, so that they manage a relatively small number of aggregated D-flows 22, rather than potentially a large number of un-aggregated D-flows 22. When aggregation is used, a forwarding-plane 94 with N nodes can support all possible traffic patterns between the N nodes, using N×N aggregated D-flows.

FIG. 9 illustrates a periodic scheduling-frame with F=16 time-slots. In this scheduling-frame, six time-slots labeled 77 are reserved for transmissions, i.e., time-slots 3,4,9,10,14,15. Each half of the periodic schedule comprises 8 time-slots. Observe that the number of time-slot reservations in each half of the periodic schedule is “relatively even”, i.e., the first half contains 2 time-slots reservations, and the second half contains 4 time-slots reservations, which is “relatively even”, given an allowable imbalance equaling for example 2 times-slots out of 16, in this example.

It is desirable that periodic schedules have the property that the number of time-slot reservations in each half of the periodic schedule is “relatively even”, to minimize queue sizes in the D-switches 96. To ensure that the forwarding-plane 94 achieves ultra-low latencies, the TDMA periodic schedules should ensure two properties. Property 1: The number of time-slot reservations to transmit data in each half of the periodic schedule, with F/2 time-slots, is “relatively even”. For example, if a TDMA schedule has transmission reservations for T time-slots in a schedule of length F, then each half of the TDMA schedule with length F/2 should have a number of reservations in the range T/2−J to T/2+J, where J is an integer indicating the allowable difference. Typically, for large F>=16, the integer J can equal T/8 or T/4. For small F<16, J can be a small integer, e.g., 2 or 4.

Property 2: The number of time-slot reservations for the transmission of data associated with one particular sub-queue 330 in each half of the TDMA schedule, with F/2 time-slots, is relatively even. For example, if a TDMA schedule has transmission reservations for T time-slots in a schedule of length F for one particular sub-queue 330, then each half of the TDMA schedule with length F/2 should have a number of reservations for said sub-queue 330 in the range T/2−J to T/2+J, where J is an integer indicating the allowable difference. The same values for integer J given in Property 1 can be used.

These properties can be applied recursively. Hence, to minimize queuing delays and jitter in the forwarding-plane 94, a periodic TDMA schedule should also exhibit these two properties: (1) The number of transmission reservations in each quarter of the TDMA periodic schedule (comprising F/4 time-slots), for all traffic, should differ by at most an “allowable-difference”. (2) The number of transmission reservations in each quarter of the TDMA periodic schedule (comprising F/4 time-slots), for one particular sub-queue 330, should differ by at most an “allowable-difference” J. For large F>=16, an allowable-difference J can equal F/4 or F/8 time-slots.

### A Deterministic-Transceiver (D-Transceiver)

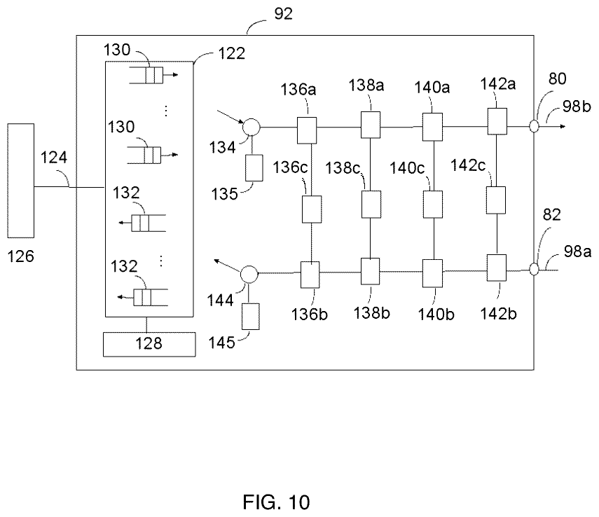

FIG. 10 illustrates a Deterministic-transceiver (D-transceiver) node 92, which can send data into and receive data from the forwarding-plane 94. (The D-transceiver 92 can also be viewed as comprising a “Deterministic-Transmitter” (D-transmitter) module, and a distinct “Deterministic-Receiver” (D-Receiver) module.) The D-transceiver 92 consists of a memory module 122, a computer system bus interface 124 from a computer system 126, and a master-controller 128. The computer system 126 can write data to transmit into the memory 122 over the bus interface 124, and it can read data which has been received and which resides in the memory 122 over the bus interface 124. The computer system 126 can write commands to control the D-transceiver 92 into the master-controller 128, and it can receive signals (such as an interrupt signal to request intervention) from the master-controller 128 over the bus interface 124. Typically, a computer system has a “Direct Memory Access” (DMA) system (not shown), which can be programmed to write larger amounts of data into the memory 122, and which can be programmed to receive larger amounts of data from the memory 122, efficiently.

The memory 122 can be divided into separate transmit-queues (or TX-queues 130), where each TX-queue 130 can buffer data to transmit for one D-flow 22. The memory 122 can be divided into separate receive queues (or RX-queues 132), where each RX-queue 132 can buffer data which has been received from one D-flow 22. The SDN control-plane 90 controls how many D-flows are buffered in each TX-queue 130 and each RX-queue 132.

Data to be transmitted is selected from a TX-queue 130 by the multiplexer 134, which is controlled by memory 135. The data then moves into a formatting unit 136a, an encryption unit 138a, a flow-label unit 140a, and a header-encryption unit 142a. The data then traverses an “electrical-to-optical” (EO) converter 80 and is transmitted onto an outgoing directed edge 98b. The flow-table unit 140a and the header-encryption unit 142a can be used when flow-labels are used in the forwarding-plane 94. If flow-labels are not used, then these two units can be disabled by the SDN control-plane 90, so that data simply passes through them without delay.

Data to be received arrives on an incoming optical fiber 98a, traverses an “optical-to-electrical” (OE) converter 82, and enters the header-decryption unit 142b. It then moves to a flow-label unit 140b, then to a decryption unit 138b, and then to the formatting-unit 136b. The header-decryption unit 142b and the flow-table unit 140b can be used when flow-labels are used in the forwarding-plane 94. If flow-labels are not used, then these two units can be disabled by the SDN control-plane 90, so that data simply passes through them without delay.

The IP protocol allows for variable-size IP packets, ranging in sizes from 128 bytes up to 64 kilobytes (Kbytes). The D-transceivers 92 are “data-agnostic”, i.e, they can transport any kind of data. In many applications, they will transport IPv4 or IPv6 packets between IP-routers 72, as described earlier. The formatting unit 136a formats data to transmit into a fixed sized packet, typically 1 Kbytes, for transmission over the forwarding-plane 94. It will add sequence number, and a CRC (“Cyclic Redundancy Check”) error control code, to each outgoing packet. CRC codes have been used to detect errors in data for years in the telecommunications industry. The sequence numbers allow for the reconstruction of larger IP packets in the RX-queue 132, at the receiving D-transceiver 92.

A formatting unit 136a can remove data from a TX-queue 130 in smaller fixed-sized “cells” of data comprising approx. 1 Kbytes. A “cell” can be viewed as fixed size packet, and will hereafter also be called a “packet”. The CRC error check code typically comprises 32 bits, and it can identify all single bit errors in a block of data, and many burst errors in which multiple bits are corrupted. The controller 136c can compute the CRC error control code and provide it to formatting unit 136a, for insertion into the outgoing packet.

The cell then moves from the formatting unit 136a to the encryption unit 138a. The cell contains approx. 1 Kbytes. In accordance with one aspect of this invention, it is desirable that a D-transceiver 92 has a plurality of encryption ciphers to select from, to provide diversity. Two popular Quantum Safe ciphers are the “Advanced Encryption Standard’ (AES), and the Chacha20 cipher, as described earlier, but any Quantum Safe ciphers can be used.

In accordance with one aspect of this disclosure, the encryption controller 138c in each D-transceiver 92 contains memory to store a large number of secret keys, for a plurality of ciphers, that may be used to encrypt and authenticate the packets of D-flows 22 before transmission over the forwarding-plane 94, in the encryption unit 138a. This encryption and authentication is happening in layer-3, the networking layer, which provides the exceptionally strong cyber-security in layer-3. The same keys can be used to decrypt the packets of D-flows 22 that have been received from the forwarding-plane 94, in the decryption unit 138b. For a packet to be accepted at a receiving D-transceiver, in layer-3, it must be successfully decrypted and authenticated at the receiving D-transceiver 92, using Quantum Safe ciphers.

In accordance with one aspect of this disclosure, the AES cipher can be used in the encryption unit 138a, and decryption unit 138b, of each D-transceiver 92, to encrypt/decrypt the packets of D-flows 22. The AES cipher is described in the document “Announcing the Advanced Encryption Standard (AES)” (reference [24]). It can encrypt blocks of data of length 128 bits, using secret keys of lengths 128, 192 and 256 bits. The AES cipher can be extended, to use secret keys with a larger number of bits, as summarized the paper by T. H. Szymanski, “The “Cyber-security via Determinism” Paradigm for a Quantum Safe Zero Trust Deterministic Internet of Things (IoT)”, (reference [1]). For example, AES can be extended to use secret keys with 512 bits and 1,024 bits, as described in reference [1], to provide exceptionally strong security, when desired.

The Chacha20 stream cipher can also be used to encrypt each cell of a D-flow 22. The Chach20 cipher is described in the document “Chacha20 and Poly1305 for IETF Protocols”, IETF RFC 8439, (reference [25]). The ChaCha20 cipher generates a stream of Quantum Safe “key-stream” data, representing Quantum Safe pseudo-random numbers, organized in blocks of 64 bytes. The Chacha20 protocol can encrypt a stream of plaintext, organized in blocks of 64 bytes. Chacha20 will perform a logical excusive-OR (XOR) of each block of key-stream data, with each block of plaintext data, to generate a block of ciphertext (encrypted data). The Chacha20 protocol can generate 256 Gigabytes of key-stream data, using a secret 256-bit key, a 96-bit nonce (a secret number used only once with each secret key) and a 32-bit internal counter.

Assume the encryption unit 138a will encrypt cells with approx. 1 Kbytes each. For each D-flow 22, a cell of data is encrypted by consuming 1 Kbytes of key-stream data. When the key-stream data is used up, given one secret key and nonce, the nonce can be incremented, to generate another 256 Gigabytes of key-stream data. Alternatively, the 96-bit nonce can be decreased to use 64-bits, and the internal counter used in Chacha20 can be increased to use 64 bits (please see RFC 8439, reference [25]). In this manner, a secret 256-bit key can generate a very large amount of key-stream data (over 16 billion Gigabytes), sufficient to encrypt a D-flow 22 sending at the full data-rate of 800 Gbps for about 5 years.

In accordance with another aspect of this disclosure, the Chacha20 cipher can be used in the encryption unit 138a, and decryption unit 138b, of each D-transceiver 92, to encrypt/decrypt the packets of D-flows 22. The encryption controller 138c can generate a very long stream of key-stream data, for each D-flow 22 that it manages, by using the Chacha20 secret key, and by changing the nonce when necessary, under the control of the SDN control-plane 90.

To provide diversity, it is also desirable to offer the use of the Chacha20 cipher, but with stronger security (i.e., a larger secret key). In accordance with another aspect of this disclosure, and extra step of processing can be added to the Chacha20 cipher, to be used in the encryption unit 138a, and decryption unit 138b, of each D-transceiver 92, to encrypt/decrypt the packets of D-flows 22. The SDN control-plane 90 can provide the D-transceiver 92 with a second secret key with 512 bits, to be used to encrypt data for this particular D-flow 22. This key will be stored in the controller 138c, along with all the other secret keys. Consider a block ciphertext data (with 512 bits) generated by the Chacha20 cipher. This block can be further processed, as follows: (i) The block can be XORed with the second secret key of 512 bits; (ii) To introduce non-linearities, each byte of the resulting block can pass through a “Substitution box” (S-box). (An S-box is a lookup table which maps a given byte to another byte.) The AES encryption algorithm specifies an S-box that can be used. (Many possible S-boxes can be used.) This option thus requires 256+512=768 bits of secret keys, and the use of an S-box, to encrypt the packets of a D-flow 22. The added computational effort is very low, and the added security is very high. The decryption unit 138b performs the reverse operations to undo the extra processing, i.e., (i) each byte of the incoming block passes through the inverse S-box, and then (ii) it is XORed with the appropriate byte of the second secret key. It is then decrypted using the Chacha20 cipher

The encryption unit 138a can also compute a “Message Authentication Code” (MAC), to authenticate the transmitted data, using a 256 bit secret key. The IETF has described Chacha20 encryption with Poly1305 authentication as Quantum Safe (please see RFC 8439, reference [25]). The encryption unit 138a can compute a MAC and append it to the packet, before the packet is encrypted in the encryption unit 138a. The decryption unit 138c can compute the MAC after decryption, to authenticate the data, when a packet of data is received from the forwarding-plane 94. Other authenticated-encryption algorithms can also be used, to provide diversity.

After a cell has been encrypted in encryption unit 138a, it moves to the flow-table unit 140b. The flow-table unit 140b is only used if flow-labels are used in the forwarding-plane 94. If flow-labels are used, then the cells have a fixed size packet header, comprising approx. 16 bytes, sufficient to store a stack of 5 flow-labels with 3 bytes each (one byte can denote the top of the stack). If flow-labels use 2 bytes each, then a stack of 5 flow-labels requires 10 bytes, and one extra byte can be used to denote the top of the stack. In this case, the packet header comprises 11 bytes. The controller 140c comprises a memory to hold a flow-table of initial flow-labels, to be used for each D-flow 22 transmitted by the D-transceiver 92. Each D-flow 22 transmitted by the D-transceiver 92 has a row in the flow-table, with its unique initial flow-label. The flow-table unit 140a will retrieve the initial flow-label assigned to a particular D-flow 22 by the SDN control-plane 90 from the flow-table, and write the flow-label into the packet header.

The header-encryption unit 142a can encrypt the packet header, when flow-labels are used. The unit 142a can be used to enhance security when flow-labels are used. If flow-labels are not used, or if enhanced security if not desired, this unit can be disabled by the SDN control-plane 90, so data just passes through it without delay. When packet headers are encrypted, then each D-switch 96 that processes a packet-header must decrypt the header, to read it. In accordance with one aspect of this disclosure, to simplify the D-switches 96, one Chacha20 secret key can be used to encrypt all the packets-headers transmitted over each directed edge 98, regardless of which D-flow 22 the packet headers belong to. In this manner, a D-switch 96 does not need to store a secret key for every D-flow 22 that it processes. Similarly, one Chacha20 secret key can be used to decrypt all the packets-headers received over each directed edge 98, regardless of which D-flow 22 the packet headers belong to. In this manner, a D-switch 96 needs only one Chacha20 secret key, to encrypt/decrypt all the packet headers on each incident directed edge 98, resulting in a significant reduction in complexity. For each directed edge 98, the D-switch 96 transmitting over said directed edge 98 will have an encryption unit 138a, with a secret key and nonce, and the D-switch 96 receiving data from said directed edge 98 will have a decryption unit 138b, with the same secret key and nonce. The SDN control-plane 90 controls all the keys and nonce in all the D-switches 96.

The formatting units 136a and 136b are controlled by controller 136c, which contains a processor and memory to compute a CRC error control code. The encryption unit 138a and decryption unit 138b are controlled by controller 138c. The controller 138c contains memory to hold a plurality of secret keys needed to encrypt and decrypt the packets. (If flow-labels are used, the packet headers can remain unencrypted in unit 138a, as they will be encrypted in unit 142a). The encryption/decryption units 138a and 138b each contain a processor and its associated memory, to compute the MAC and the encrypted packet. (The processor and memory can also be moved into the controller 138c.) The flow-label units 140a and 140b are controlled by controller 140c, which contains memory to store a flow-table. The header encryption unit 142a and header decryption unit 142b are controlled by controller 142c, which contains: (i) memory to hold a secret key associated with the directed edge 98; (ii) a processor and memory to compute the key-stream data. The key-stream data can be forwarded to the units 142a and 142b, to be XORed with the packet header, to perform encryption or decryption of the packet header. The header encryption unit 142a can also compute a small CRC error control code just for the packet header, and the header decryption unit 142b can check for bit errors in the packet header. (Packets with bit errors can be discarded, assuming that redundant copies of each D-flow 22 were transmitted over the forwarding-plane 94 by the SDN control-plane 90, as described earlier.)

The use of Chacha20 in a D-switch 96, to encrypt/decrypt all the packet headers on a directed edge 98, allows for a significant reduction in complexity in a D-switch 96, by avoiding the need for a D-switch 96 to store all the secret keys for all the D-flows 22 that it processes. However, the use of Chacha20 still requires a D-switch 96 to perform a modest amount of processing to compute key-stream data for each directed edge 98 that it manages. In accordance with another aspect of this disclosure, as an alternative to the use of Chacah20 to encrypt and decrypt packet headers on each directed edge 98, a plurality of simple “Linear Feedback Shift Registers” (LFSRs) can be used to generate good quality key-streams of “pseudo-random” numbers.

For example, 3 LFSRs can be configured by the SDN control-plane 90. LFSRs are defined by a feedback polynomial, typically with a length of L=8 to 200 bits. An LFSR generates a pseudo-random bit stream, that repeats after (2 raised to the exponent L)−1 bits. Two LFSRs, denoted LFSR(a) and LFSR(b), can each generate key-stream data. A third LFSR denoted LSFR(c) can generate a stream of control bits. If the control bit=0, then one bit of key-stream data is selected from the LFSR(a). If the control bit=1, then one bit of key-stream data is selected from the second LFSR(b). The resulting key-stream is “pseudo-random” and can also be used to encrypt and decrypt packet headers, at each end of a directed edge 98. LFSRs require very little processing, to generate key-stream data.

Each LFSR can be configured with a feedback polynomial of length L, and an initial state of length L. Configuring 3 LFSRs with lengths of about 128 each, will result in about 768 bits of secret data, which is stored in the controller 142c, which is used to configure an header-encryption unit 142a or header-decryption unit 142b. If the lengths of the LFSRs are large and relatively prime (i.e., 127, 131, and 137), then the output bit stream should not repeat until the product of the lengths of each LFSR, an exceptionally long time. This scheme also generalizes, to use more LFSRs, i.e., 4 LFSRs could generate key-stream data, and two control-bits could select data from one of 4 LFSRs. Quantum computers have difficulty cracking systems with “non-linearities”. To add some non-linearity, each byte of key-stream data can pass through a substitution-box (S-box), e.g., a lookup table, as described earlier.

Data received by a D-transceiver 92 undergoes the reverse process that was just described. The data is received at an “optical-to-electrical” (OE) converter 82. It moves to a header-decryption unit 142b, then to a flow-table unit 140b, then to a decryption unit 138b, and then to the formatting unit 136b. If flow-labels are not used in the forwarding-plane 94, then the header-decryption unit 142b and the flow-table unit 140b are not necessary, and they can be bypassed by the SDN control-plane 90, so data simply passes through them without delay.

If flow-labels are used in the forwarding-plane, the header-decryption unit 142b will decrypt the packet header. The flow-table unit 140b will extract the incoming flow-label, and access a row of data in the flow-table in the controller 140c, to identify the D-flow 22 that is being received. The decryption controller 138c will retrieve the secret key(s) needed to decrypt this particular D-flow 22. The decryption unit 138b will perform the decryption of the packet, and it will verify the integrity and authenticity of the data by computing a “Message Authentication Code” (MAC). If the decryption fails, or if the computed MAC code does not match the MAC code in the packet, then the packet is assumed to be malicious, i.e., it may be a packet from an external cyber-attacker. It will not be accepted into an RX-queue 132, and the SDN control-plane 90 will be informed that an anomaly has been detected.

The “electrical-to-optical” (EO) converter 80 can also be an electrical-to-wireless converter, to enable the use of these concepts in deterministic wireless networks. The EO converter 80 can also be an electrical-to-electrical converter, to enable the use of these concepts in deterministic electrical networks, i.e., local area networks. The “optical-to-electrical” (OE) converter 82 can be replaced by a wireless-to-electrical converter, to enable the use of these concepts in deterministic wireless networks. The OE converter 82 can also be an electrical-to-electrical converter, to enable the use of these concepts in deterministic electrical networks, i.e., local area networks.

The master-controller 128 can send encrypted messages to the SDN control-plane 90 to request service, or to inform the SDN control-plane 90 that a malicious packet has been received. The master-controller 128 can also receive encrypted messages from the SDN control-plane 90. These messages may contain deterministic schedules and/or secret keys, needed to configure the D-transceiver 92. (The SDN control-plane 90 can create a D-VPN to support the communications between itself and the D-transceivers 92 and D-switches 96, over which the master-controller 128 can communicate with the SDN control-plane 90.)

The computer system 126 can request a D-flow 22 to be established, from its D-transceiver 92 (the source of data), to the D-transceiver 92 of a remote computer system (not shown) which is the destination of the data. The D-flow 22 may propose a deterministic rate requirement and, potentially, deterministic bounds to the latency, jitter and reliability. The computer system 126 can request a specific cipher, level of security for the D-flow, e.g., a key length for the secret symmetric keys, as described in the flow-chart (ahead).

### A D-Transceiver Used as a Deterministic Transmitter

Consider a D-transceiver 92 which transmits data for a D-flow 22 into the forwarding-plane 94. If the request for a D-flow 22 is approved by AC/AC control system 19, the master-controller 128 will receive a confirmation message from the SDN control-plane 90, with permission to transmit a new D-flow 22. If flow-labels are used, the master-controller 128 will receive an initial flow-label to be used in the packet header, to identify packets that below to the D-flow 22, from the SDN control-plane 90. That initial flow-label is written into the flow-table in controller 140c. The master-controller 128 will be informed of the cipher to use, and will receive a secret key to encrypt/decrypt the D-flow 22, from the SDN control-plane 90. These secret keys are stored in controller 138c. The master-controller 128 may also receive a secret key to compute a “Message Authentication Code” (MAC) for the D-flow 22 (using for example the Poly1305 algorithm), from the SDN control-plane 90. These secret keys are stored in controller 138c. To meet reliability requirements, the SDN control-plane 90 may transmit redundant copies of the D-flow 22, over edge-disjoint paths, in the forwarding-plane 94. Each of these redundant paths could also use a distinct set of secret keys.

The master-controller 128 will receive a deterministic periodic (repeating) TDMA schedule, valid for a periodic (repeating) scheduling-frame with F time-slots, which specifies which TX-queue 130 (if any) has a reservation to transmit data, in each time-slot of the periodic scheduling-frame. That schedule is stored in memory 135. The master-controller 128 will also receive a deterministic periodic TDMA schedule, valid for a periodic scheduling-frame with F time-slots, which specifies which RX-queue 132 (if any) has a reservation to receive data, in each time-slot of the periodic scheduling-frame. This schedule is stored in memory 145. In accordance with one aspect of this disclosure, these deterministic schedules dramatically increase the cyber-security of a D-transceiver 92, by defining the precise time-slots within a periodic scheduling-frame, in which data can be transmitted into the forwarding-plane 94, and by defining the precise time-slots within a periodic scheduling-frame, in which data may be received from the forwarding-plane 94. In accordance with one aspect of this invention, these TDMA schedules implement a “Guaranteed Intrusion Detection System.”

To ensure that the forwarding-plane 94 achieves ultra-low latencies, the TDMA schedules of length F-time-slots should ensure two properties, as mentioned earlier. Property 1: The number of time-slot reservations to transmit data from one particular TX-queue 130 in each half of the periodic schedule, with F/2 time-slots, is “relatively even”. Property 2: The number of time-slots reserved for the transmission of data associated with one particular D-flow 22 in each half of the TDMA schedule, with F/2 time-slots, is “relatively even”. These properties should apply recursively as well, i.e., each half of the TDMA schedule with F/2 time-slots should adhere to these properties.

### A D-Transceiver Used as a Deterministic Receiver

Consider a D-transceiver 92 which receives data for a D-flow 22 from the forwarding-plane 94. If a request for a new D-flow 22 is approved by AC/AC control system 19, the master-controller 128 will receive a confirmation message from the SDN control-plane 90, with notification that it will receive data for a new D-flow 22. If flow-labels are used, the master-controller 128 will be informed of the cipher used, and will receive a flow-label that will be used in the packet header, to identify packets that below to the new D-flow 22. That flow-label is written into the controller 140c, to associate the incoming packets with the newly created D-flow 22. The master-controller 128 will receive a secret key(s) for the D-flow 22, to be used to decrypt the data in the packets. The master-controller 128 may receive a secret key for the D-flow 22, to be used to compute a “Message Authentication Code” (MAC). That secret key is also written into controller 138c. If redundant copies of the D-flow 22 were transmitted for improved reliability, the receiving D-transceiver 92 is informed of the redundant D-flows 22, so that it can process the received data, and reconstruct a single D-flow 22 (by eliminating duplicate copies of any packet). Alternatively, the computer system 126 can receive all the data from the redundant D-flows 22, and reconstruct a single D-flow 22.

The master-controller 128 will receive a deterministic periodic TDMA schedule, valid for a periodic scheduling-frame with F time-slots, which specifies which RX-queue 132 (if any) has a reservation to receive data, in each time-slot of the periodic scheduling-frame. To ensure that the forwarding-plane 94 achieves ultra-low latencies, the TDMA schedules should ensure that the time-slots reserved for the reception of data for each RX-queue 132 are distributed “relatively evenly”, over each half of the scheduling-frame, as described earlier.

The ciphers used to encrypt/decrypt data should be “Quantum Safe,” i.e., they should be immune to being decrypted by a cyber-attacker who has access to a quantum computer. The AES and Chacha20 ciphers, using 256 bit keys, are considered to be Quantum Safe. A transmitted packet may include a “Message Authentication Code” (MAC), which also requires a secret key. The Poly1305 MAC is widely used in industry, and has been standardized by the IETF. It uses a 256-bit key and a 96-bit nonce. The data in a packet to be protected is processed by the Poly1305 algorithm, to generate a MAC which is appended to the data. The data and MAC can then be encrypted, before transmission. Upon decryption, the destination can recompute the MAC code, using the secret key and nonce, to authenticate the message and verify its integrity.

### D-Transceiver Performing an Authorization Check

A D-flow 22 that belongs to a “Deterministic Virtual Private Network” (D-VPN) represents an “Authenticated Encrypted Deterministic Channel” (AEDC 22), as described earlier. The IETF Chacha20 and Poly1305 algorithms are described in reference [25], the IETF RFC 8439, entitled “Chacha20 and Poly1305 for IETF protocols”). The packets belonging to an AEDC can be encrypted with a Quantum Safe Chacha20 cipher, and can include a Poly1305 “Message Authentication Code” (MAC). (Other algorithms can be used as described earlier.) Every such packet that is received at a D-transceiver 92 will be decrypted and its authenticity and integrity will be verified. In accordance with one aspect of the present application, if a packet fails the decryption or authentication/integrity check, it is classified as a “malicious” packet from an external cyber-attacker. That packet is not buffered in an RX-queue 132. The D-transceiver 92 will send an encrypted message to the SDN control-plane 90, informing the SDN control-plane 90 that a malicious packet has been detected.

In order for a malicious packet from an external cyber-attacker to be accepted at a D-transceiver 92, the external cyber-attacker must crack a Quantum Safe cipher with a secret key of at least 256 bits. It is shown in reference [1] by T. H. Szymanski, entitled “The “Cyber-Security via Determinism” Paradigm for a Quantum Safe Zero Trust Deterministic Internet of Things”, that there is not enough time in the life of the universe, for a quantum computer to crack a secret symmetric key cipher with 256 bit keys, using current quantum technologies. Hence, the probability that a malicious packet from an external cyber-attacker is accepted as a valid packet at a D-transceiver 92 is effectively zero. Thus, any packet injected into the forwarding-plane 94 by an external cyber-attacker will be detected as a malicious packet by a D-transceiver 92 with overwhelming probability close to 1.0, and the SDN control-plane 90 will be informed.

### A D-Switch Using “Input Queues”

FIG. 11A illustrates a D-switch 96 using “Input Queues” (IQs). In general, a D-switch 96 can have N input ports 300 to receive incoming data, and M output ports 340 to transmit outgoing data, for integers N and M. Consider a D-switch 96 of degree N, with N input ports 300 and N output ports 340. This D-switch receives data arriving on N incoming directed edges 98a, and it transmits data onto N output directed edges 98b. The D-switch 96 comprises an unbuffered crossbar switch 380, to provide connections between the input ports 300 and output ports 340. The D-switch 96 also has a main switch-controller 370. The switch-controller 370 can receive encrypted packets from the SDN control-plane 90, decrypt said packets, and thus receive messages from the SDN control-plane 90. The switch-controller 370 may receive encrypted messages from the SDN control-plane 90, that contains deterministic schedules and secret keys, which are used to configure the D-switch 96, as explained ahead. The switch-controller 370 can also encrypt data and send encrypted packets to the SDN control-plane 90.

In FIG. 11A, the D-switch of degree N has N×N “Virtual Output Queues” (VOQs 320), where each VOQ(j,k) 320 is associated with one input port(j) 300 and one output port(k) 340, for integers j and k where 1<=j<=N, and 1<=k<=N. Each VOQ(j,k) 320 buffers data which is received at input port(j) 300, and which will depart from output port(k) 340. Each input port(j) 300 thus comprises N VOQs 320, including VOQ(j, 1), . . . , VOQ(j,N) 320, each of which receives data which arrives at input port(j) 300.

Each input port 300 contains an “optical-to-electrical” (OE) converter 82, a buffer 304 to store incoming data, a decryption unit 306, a flow-table unit 308, a de-multiplexer 310, a memory 312 to store a periodic schedule to control the de-multiplexer 310, and N VOQs 320, to buffer data. (The OE converter 82 can also be a wireless-to-electrical converter, to enable the use of wireless edges. It can also be an electrical-to-electrical converter, to enable the use of electrical edges.) The input port 300 also contains a multiplexer 322 to select data to forward from a VOQ 320 to an output port 340, and memory 324 to store a periodic schedule to control the multiplexer 322. In practice, the N VOQs 320 within one input port 300 can reside in one logical memory module (not shown in FIG. 11A), which is partitioned into N smaller VOQs 320 by using pointers to memory.

The decryption unit 306 is used to decrypt a packet header, only if flow-labels are used in the forwarding-plane 94. If flow-labels are not used, then this decryption unit 306 is not necessary. It can be bypassed, or it can be completely removed. For a flexible design of a D-switch 96, the switch-controller 370 could simply disable the decryption unit 306 if flow-tables are not used, so that data passes through the decryption unit 306 without delay. Furthermore, flow-labels can also be used in the forwarding-plane 94, without encrypting and decrypting the packet headers while they traverse directed edges 98. The security of the forwarding-plane 94 is still preserved, since all packets in a D-VPN which are received at a D-transceiver 92 must be successfully decrypted, and only the packets of approved D-flows 22 will be successfully decrypted, given that Quantum Safe ciphers are used.

The flow-table unit 308 is used to read the incoming flow-label from the decrypted packet header, only if flow-labels are used. If flow-labels are not used, then this flow-table unit 308 is not necessary. It can be bypassed, or it can be completely removed. For a flexible design of a D-switch 96, the switch-controller 370 could simply disable the flow-table unit 308 if flow-tables are not used, so that data passes through unit 308 without delay.

All the memories memory (312 and 324) are effectively “Look Up Tables” (LUTs) that stores a periodic (repeating) schedule, for a periodic scheduling-frame which contains F time-slots, for integer F.

The IQ switch has N output ports 340. In general, an output port 340 can contain N “output queues” (OQs) (not shown in FIG. 11A), where OQ(j,k) stores data which is received at input port(j) 300, and which will depart from output port(k) 340. Data which arrives at an output port 340 from a VOQ 320 is buffered in the appropriate output queue. One output queue can transmit data in each time-slot, according to a periodic schedule determined by the SDN control-plane 90. However, the D-switch 96 design can be simplified by avoiding output queues.

In FIG. 11A, data which arrives at an output port 340 is stored in a buffer 342. The buffer 324 forwards the data to an encryption unit 344, that will be explained ahead. The data is then converted from “electrical to optical” (EO) format in an EO-converter 80, and transmitted over an outgoing directed edge 98b. (The EO-converter 80 can also be an “electrical-to-wireless” converter, to enable the use of wireless edges. It can also be an ‘electrical-to-electrical converter, to enable the use of electrical edges.)

The encryption unit 344 can be used to encrypt a packet header, only if encrypted flow-labels are used. If encrypted flow-labels are not used, then this encryption unit 344 is not necessary. It can be bypassed, or it can be completely removed. For a flexible design of a D-switch 96, the switch-controller 370 could simply disable the encryption unit 344, if encrypted flow-tables are not used, so that data passes through unit 344 without delay.

In FIG. 11A, the crossbar switch 380 can deliver up to N packets, from distinct input ports 300 to distinct output ports 340, in each time-slot of the periodic scheduling-frame. The crossbar switch 380 has an associated memory 382, to store a deterministic periodic schedule of switch configurations, where each switch configuration specifies up to N VOQs 320 to receive service, for each time-slot of the periodic scheduling frame. Each switch configuration provides connections through switch 380, between the input ports 300 and output ports 340. The memory 382 is effectively a “Look Up Table” (LUT). The switch-controller 370 can configure the memory 382, under the control of the SDN control-plane 90.

FIG. 11B illustrates a VOQ 320 in detail. In accordance with one aspect of this disclosure, a VOQ 320 comprises a plurality of sub-queues 330. A VOQ 320 can buffer data associated with many different D-flows 22, potentially 10s or 100s of D-flows 22. Each sub-queue 330 can buffer data associated with one or more D-flows 22, as determined by the SDN control-plane 90.

For the D-switch in FIG. 11A, the SDN control-plane 90 can provide the switch-controller 370 with several deterministic periodic schedules, to control each input port 300. In each input port 300, the switch-controller 370 can assign a deterministic periodic schedule to memory 312. If flow-tables are not used, the schedule in memory 312 will identify which VOQ 320 (if any), has a reservation to receive data in each time-slot in the periodic scheduling-frame. A periodic schedule in memory 324 shown in FIG. 11B will identify the sub-queue 330 with a reservation to receive data in each time-slot in the periodic scheduling-frame. (The two memories 312 and 324 can also be combined into one memory, and the two schedules can also be combined into one schedule.)

If flow-tables are used in the forwarding-plane 94, the schedule in memory 312 will identify the time-slots within the periodic scheduling-frame, in which a VOQ 320 within the input port 300 has a reservation to receive data. In this case, the k bits of data 104 extracted from the flow-table 100 will identify the output port(k) 340 from which this packet must depart, which thus identifies the VOQ 320 to receive the data. The sub-queue-identifier bits 106 extracted from the flow-table 100 will control demultiplexer 326 in FIG. 11B, to select a sub-queue 300 to receive the data.

In FIG. 11B, at each input port, the switch-controller 370 can assign a deterministic periodic schedule to memory 334, to control the rate at which each VOQ 320 forwards data to an output port 340. This periodic schedule will identify the VOQ 320 (if any) with a reservation to forward data to an output port 340, for each time-slot in the periodic scheduling-frame. This schedule will control multiplexer 332 in FIG. 11B. The switch-controller 370 can receive all the deterministic periodic schedules from the SDN control-plane 90, to keep the D-switch 96 design simple and secure.

Methods to compute low-jitter schedules for a D-switch 96 using IQs are described in the following documents by T H. Szymanski: (i) “An Ultra-Low-Latency Guaranteed-rate Internet for Cloud Services”, reference [4]; (ii) “A Low-jitter Guaranteed-Rate Scheduling Algorithm for Packet-Switched IP Routers”, reference [5]; (iii) “Reduced Complexity Integrated Guaranteed-Rate Optical Packet Switch”, reference [7]; (iv) “Methods to Achieve Bounded Buffer Sizes and Quality of Service Guarantees in the Internet Network”, reference [9]; (v) “Method to schedule multiple traffic flows through packet-switched routers with near-minimal queue sizes”, reference [11]; (vi) “Method and apparatus to schedule packets through a crossbar switch with delay guarantees”, reference [13].

According to one aspect of this disclosure, a VOQ 320 comprises several sub-queues 330, and the sub-queues 330 can comprise 2 types: (i) each sub-queue 330a buffers data for only one particular D-flow 22; (ii) each sub-queue 330b buffers data for a plurality of D-flows 22, which share the same “traffic class”. According to another aspect of this disclosure, for maximum flexibility, the SDN control-plane 90 can define how many sub-queues of each type exist in each D-switch 96. The SDN control-plane 90 can define how many sub-queues 330a exist in each VOQ 320 in each D-switch 96, and how many sub-queues 330b exist in each VOQ 320 in each D-switch 96.

For example, the SDN control-plane 90 can operate a D-switch 96 only using sub-queues 330a which buffer individual D-flows 22. This approach may lead to the use of a large number of sub-queues 330a in each VOQ 320, each of which receive customized service. The SDN control-plane 90 can also operate the D-switch 96 only using sub-queues 330b, each of which buffers data for a plurality of D-flows 22. This approach will lead to the use of a smaller number of sub-queues 330b in each VOQ 320, as each sub-queue 330b buffers data for a plurality of D-flows 22, which receive shared FCFS service. A balanced approach will allow the SDN control-plane 90 the flexibility to use a reasonable number of sub-queues 330a, and/or a reasonable number of sub-queues 330b.

According to another aspect of this disclosure, to support a flexible design, approx. two bytes of data in a flow-table can identify a sub-queue 330 within a VOQ 320. This data field is called the “sub-queue-identifier” 106. For example, the SDN control-plane 90 can use 12 bits (out of 2 bytes) for the sub-queue-identifier. In this manner, a VOQ 320 can contain a total of 4K sub-queues 330, which can be partitioned into sub-queues 330a and sub-queues 330b by the SDN control-plane 90, as needed. (By using all 16 bits for the sub-queue-identifier, a VOQ 320 can contain 64K sub-queues 330. The sub-queue-identifier can also use fewer than or more than 2 bytes, to select a sub-queue 330, if necessary.)

According to another aspect of this disclosure, the D-flows 22 buffered in a sub-queue 330b may receive simple “First Come First Served” (FCFS) service (or another simple service such as random service.). The use of FCFS service simplifies the scheduling of traffic, as the need to maintain periodic schedules for individual D-flows 22 within a traffic class sub-queue 330b is eliminated. One periodic schedule is sufficient to service all the D-flows 22 within a sub-queue 330b.

In FIG. 11B, when data is received at a VOQ 320, it is forwarded to the appropriate sub-queue 330 by a demultiplexer 326. When flow-labels are not used, the demultiplexer 326 can be controlled by a memory 324 (also called a “Look Up Table” or LUT), which stores a periodic schedule to control said demultiplexer 326, for F time-slots in the periodic scheduling-frame. When flow-labels are used, the sub-queue 330 is selected according to the sub-queue-identifier bits 106 extracted from the flow-table 100, as explained earlier. The VOQ 320 also contains a multiplexer 332, to select data to forward from a VOQ 320 to an output port 340, when said VOQ 320 receives service. The multiplexer 332 can be controlled by a memory 334. The well-known “Generalized Processor Sharing” (GPS) algorithm in references [21] and [22] can be used to compute periodic schedules for memories 324 and 334.

Each sub-queue 330 has a deterministic data-rate requirement, equal to the sum of the data-rate requirements of the D-flow(s) 22 for which it buffers data. When a VOQ 320 receives service, this service should be allocated to the sub-queues 330 within said VOQ 320, according to their deterministic data-rate requirements, as stated hereinbefore. The SDN control-plane 90 can compute a deterministic periodic schedule to identify a plurality of VOQs 320 (if any) with reservations to forward data, for each time-slot in a periodic scheduling-frame. This schedule is stored in memory 382. The SDN control-plane 90 can also compute a deterministic schedule, which identifies which sub-queue 330 (if any) within a VOQ 320 (if any), has a reservation to forward data, in each time-slot of the periodic scheduling frame. This schedule can be stored in memory 334 by the switch-controller 370. (The memories 324 and 334 can be combined, and the schedules can also be combined into one larger schedule.)

According to another aspect of this disclosure, when flow-tables are not used, the SDN control-plane 90 can also compute a deterministic schedule, which identifies the sub-queue 330 (if any) within a VOQ 320, (if any), with a reservation to receive data, in each time-slot of the periodic scheduling frame. This schedule can be stored in memory 324 by the switch-controller 370. These schedules can be computed by the SDN control-plane 90 for each VOQ 320 in a D-switch 96, and stored in memories by the switch-controller 370, and re-used as long as the data-rate requirements do not change. Preferably, these schedules are low-jitter schedules, to minimize the queue sizes, delays and jitter. Methods to compute low-jitter schedules for sub-queues 330 are described in reference [4] by T. H. Szymanski, entitled “An Ultra-Low-Latency Guaranteed-rate Internet for Cloud Services”, and references [21] and [22] which describe the well-known “Generalized Processor Sharing” algorithm.

In accordance with one aspect of this disclosure, the D-switch 96 in FIG. 11A allows for use of deterministic schedules to enable data to traverse said D-switch 96 in layer-3, without the need to process IP packet headers. This deterministic behavior eliminates many cyber-security vulnerabilities that have existed in layer-3 (IP) of the Consumer IoT 4 for many decades. It eliminates the need to process: (i) unencrypted IP packet headers; and (ii) unauthenticated IP packet headers. Therefore, packets can be completely encrypted with Quantum Safe ciphers as they traverse the forwarding-plane 94 from end-to-end.

In accordance with one aspect of this disclosure, if flow-labels are used, then a D-switch 96 can decrypt the packet headers on each directed edge 98, using a single Quantum Safe cipher associated with each directed edge 98, as explained earlier. The D-switch 96 can process the packet headers, and then efficiently encrypt the packet header, using a single Quantum Safe cipher associated with each directed edge 98, as explained earlier. The rest of the packet (everything except the packet header) can be completely encrypted with Quantum Safe ciphers by a D-transceiver 92 before it traverses the forwarding-plane 94 from end-to-end.

FIG. 11C illustrates the decryption unit 306 in a D-switch 96. It is only used if encrypted flow-labels are used in the packets. It comprises a buffer 360, a logic module 362 to compute a stream of pseudo-random numbers, and a memory 364, to store a secret key(s) and one-time random number (nonce), received from the SDN control-plane 90.

As described earlier, the ChaCha20 cipher can generate a stream of Quantum Safe “key-stream” data, representing Quantum Safe pseudo-random numbers, organized in blocks of 64 bytes. The Chacha20 protocol can generate 256 Gigabytes of key-stream data, using a 256 bit key and a 96 bit nonce (a random number, used only once). Assume the decryption unit 306 will decrypt a packet header that contains flow-labels, comprising approximately 18 bytes. These 18 bytes must be decrypted, by XOR these bytes with a key-stream comprising 18 bytes.

A directed edge 98 operating at 800 Gigabits/second (Gbps) using 1 Kbyte packets will consume key-stream data at the rate of about 1.8 Gigabytes/second to decrypt the packet headers. It will consume the 256 Gigabytes of key-stream data generated by Chacha20 within about 3 minutes. However, one can decrease the size of the nonce from 96 bits to 64 bits in Chacha20, and increase the internal counter from 32 bits to 64 bits, to generate more key-stream data, as described in the document by Nir and Langley, entitled “Chacha20 and Ploy1305 for IETF protocols”, reference [25]. This method can generate a key-stream with 16 billion Gigabytes, using a 256 bit key and 64 bit nonce. This method can thus encrypt/decrypt packet headers over an 800 Gbps directed edge 98 for over approx. 5 years. The nonce can then be incremented by 1 to allow for another 5 years of operation.

In FIG. 11C, memory 364 can contain the secret key and nonce needed to decrypt packet-headers for one particular directed edge 98. A controller 362 contains a processor and memory, to compute the key-stream data, given the secret key and nonce. The buffer 360 will receive a packet, it will also receive the approx. 18 bytes of key-stream data from the controller 362, and it will XOR the key-stream data with the packet-header, to decrypt the packet header. The key-stream data is only used once, so the next packet-header to decrypt will use the next set of 18 bytes of key-stream data. (The packet-headers can also use fewer or more bytes, depending upon the desired depth of the label stack.).

Data is transmitted over directed edges 98b. Each end of a particular directed edge 98 must use the same secret key and nonce, to encrypt/decrypt the packet-headers, when flow-labels are used in the forwarding-plane 94. The SDN control-plane 90 will provide each directed edge 98 with a unique secret key and nonce, to encrypt/decrypt packet-headers.

In accordance with one aspect of this disclosure, the Chacha20 cipher can be used (with adjustments) in the decryption unit 306 (and in the controller 362), to decrypt packet-headers on a directed edge 98. The nonce size can be reduced to 64 bits, and the internal counter size can be increased to 64 bits, to generate approx. 16 billion Gigabytes of key-stream data, sufficient to encrypt packet-headers on an 800 Gbps directed edge 98 for many years.

In accordance with another aspect of this disclosure, as an alternative to the use of Chacah20, a plurality of “Linear Feedback Shift Registers” (LFSRs) can be used to generate good quality key-streams of “pseudo-random” numbers, as described for the D-transceiver 92 shown in FIG. 10. For example, 3 LFSRs can be configured by the SDN control-plane 90. Two LFSRs generate key-stream data, and a third LFSR generates control-bits, used to select key-stream bits from either the first of second LFSR. The resulting key-stream is pseudo-random and can also be used to encrypt and decrypt packet headers, at each end of a directed edge 98. This scheme also generalizes to use more LFSRs. To add some non-linearity, each byte of output can pass through a substitution-box (S-box), in which an incoming byte is mapped to an outgoing byte, according to a lookup table.

The flow-table unit 308 is shown in FIG. 11D. It is used only if flow-labels are used in the forwarding-plane 94. It comprises a buffer 370, a controller module 372, and a flow-table memory 374. The flow-table memory 374 contains a row of a data, for each D-flow 22 that traverses the D-switch 96. This flow-table unit 308 will read the incoming flow-label from the decrypted packet-header. In accordance with one aspect of this disclosure, the controller 372 will access the flow-table 100 in memory 374, to extract: (i) an outgoing flow-label 102; (ii) an integer k 104 denoting the output port(k) from which the packet must depart; and (iii) a sub-queue-identifier 106, to identify the sub-queue 330 to buffer the incoming packet. This controller 372 will write the outgoing flow-label into the packet header, over-writing the incoming flow-label, for the packet in the buffer 370.

In FIG. 11A, when flow-labels are used in the forwarding-plane 94, the integer k 104 extracted from the flow-table 100 is used to control the demultiplexer 310, to direct the packet into the appropriate VOQ 320. Similarly, the sub-queue-identifier 106 extracted from the flow-table 100 will be used to control demultiplexer 326 in FIG. 11B, to select the sub-queue 330 within the VOQ 320, with a reservation to receive a packet. In accordance with one aspect of this disclosure, when flow-labels are used in the forwarding-plane 94, then: (i) the memory 312 can store a periodic schedule, which indicates the time-slots in the periodic scheduling-frame, in which some VOQ 320 has a reservation to receive data; (ii) the memory 324 can store a periodic schedule, which identifies the time-slots within a periodic scheduling-frame, in which some sub-queue 330 has a reservation to receive data. These schedules can be used to significantly strengthen cyber-security, by detecting the arrival of data in time-slots for which no reservation for the arrival of data has been made.

In accordance with one aspect of this disclosure, the use of deterministic schedules for the D-switch 96 in FIG. 11A provides several benefits: (i) It provides each VOQ 320 with a deterministic rate of service, sufficient to satisfy its deterministic data-rate requirement; (ii) It provides each sub-queue 330 with a deterministic rate of service, sufficient to satisfy its deterministic data-rate requirement; (iii) It provides a deterministic periodic schedule, to identify the time-slots in which data has reservations to arrive, for each input port 300 of a D-switch 96 in the forwarding-plane 94; (iv) It provides a deterministic periodic schedule, to identify the time-slots with transmission reservations, over each directed edge 98 in the forwarding-plane 94. This plurality of deterministic schedules identifies the transmissions of approved data for D-flows 22, approved by the AC/AC system 19. Any other data transmissions at any other times represent anomalies, i.e., potentially packets from an external cyber-attacker. These anomalies are easily detected, as they violate a deterministic schedule, and the SDN control-plane 90 can be informed of the anomaly, thus implementing a “Guaranteed Intrusion Detection System.”

In accordance with one aspect of this disclosure, the use of a sub-queue-identifier 106 in a flow-table 100, and the use of sub-queues 330 within each VOQ 320, allows for a flexible design of a D-switch 96. Each sub-queue 330a can buffer data for one particular D-flow 22, and hence deterministic service can be specified in a deterministic schedule for this particular sub-queue 330 and this particular D-flow 22. This option can be used to provide deterministic service to individual D-flows 22, which may support critical applications such as nuclear reactors. The use of sub-queue-identifiers 106 also enables the use of sub-queues 330b, which buffer the data for a plurality of D-flows 22 which share the same traffic class. The data buffered within a sub-queue 330b may receive “First Come First Served” (FCFS) service. This option can be used to provide deterministic service to each class of traffic, without providing deterministic schedules to provide service for individual D-flows 22. The forwarding-plane 94 can, thus, support several traffic classes, with priorities.

### A D-Switch Using Crosspoint-Queues” (XQs)

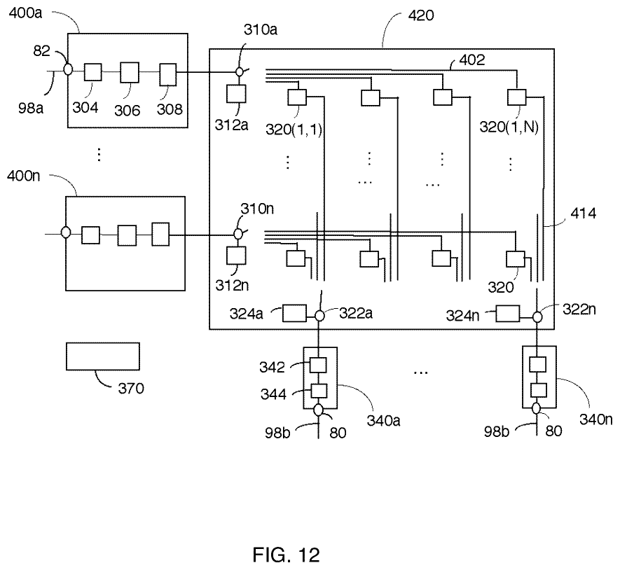

FIG. 12 illustrates a D-switch 96 using “Crosspoint Queues” (XQs). In general, a D-switch 96 using XQs can have N input ports 400 and M output ports 340, for integers N and M. A D-switch 96 with degree N, with N input ports 400 and N output ports 340, is shown in FIG. 12 A typical D-switch 96 using XQs also has N input fibers 98a, and a buffered crossbar switch 420 with N×N VOQs 320. The VOQs 320 shown in FIG. 11A have been moved into the crossbar switch 420 in FIG. 12. The operations of the VOQs 320 shown in FIG. 12 remains unchanged from VOQs 320 shown in FIG. 11A, i.e., the description of their operation is the same. This D-switch 96 using XQs shown in FIG. 12 tends to be easier to schedule than the D-switch 96 using IQs shown in FIG. 11A.

The D-switch 96 also has a main switch-controller 370. The operations of the switch-controller 370 in FIG. 12 remains unchanged from switch-controller 370 shown in FIG. 11A i.e., the description of its operation is the same.

Input port 400 contains an optical-to-electrical (OE) converter 82, a buffer to store incoming data 304, a decryption unit 306, and a flow-table unit 308. Incoming data is buffered in buffer 304. The operation of the decryption unit 306 in FIG. 12 remains unchanged from the operation of the decryption unit 306 in FIG. 11A. The operation of the flow-table unit 308 in FIG. 12 remains unchanged from the operation of the flow-table unit 308 in FIG. 11A.

In FIG. 12, each input port 400 is associated with one row of the buffered XQ switch 420, and each output port 340 is associated with one column of the XQ switch 420. The XQ switch 420 has N×N VOQs 320. Each input port 400 is connected to a demultiplexer 310 in one row of the XQ switch 420, which can be controlled by memory 312. Each de-multiplexer 310 is connected to N horizontal wires 402 which lead to the N VOQs 320 in that row. Each output port 340 receives a packet from a multiplexer 322 in one column of the switch, which is controlled by a memory 324. The multiplexer 322 is connected to the VOQs 320 in a column, by several vertical wires 414. The operation of the demultiplexer 310, the memory 324, the multiplexer 322, the memory 324 and the output port 340 in FIG. 12 remain unchanged from the operation of the same component in FIG. 11A.

An output port 340 contains a buffer 342, an encryption unit 344, and an electrical-to-optical (EO) converter 80. The operation of the output port 340 and encryption unit 344 in FIG. 12 is the same as the operation of the same components in FIG. 11A.

### A D-Switch Using XQS and Deterministic Schedules

For a deterministic D-switch 96 using XQs, several deterministic schedules can be computed to control how data is forwarded in each row of the switch 400. The methods to compute deterministic periodic schedules for the D-switch 96 using XQs in FIG. 12 is nearly identical the methods used to compute deterministic periodic schedules for the D-switch 96 using IQs in FIG. 11A, with a few minor exceptions, as explained next.

In FIG. 12, within the XQ switch 420, for each column k the memory 324(k) can contain a periodic schedule to control multiplexer 322(k), to identify which VOQ 320 in that column has a reservation to forward data to the output port 340(k), in each time-slot of the periodic scheduling-frame. This feature is the primary simplification of the D-switch 96 using XQs (FIG. 12) over the D-switch 96 using IQs (FIG. 11A). Each column can be scheduled independently from the other columns. The deterministic schedule stored in memory 382 in FIG. 11A can be eliminated.

Methods to compute periodic schedules for a D-switch 96 using XQs are described in the references [10] and [11] by T. H. Szymanski, entitled “Crossbar Switch and Recursive Scheduling”, and “Method to schedule multiple traffic flows through packet-switched routers with near-minimal queue sizes”. Additional methods are described in reference [4] by T. H. Szymanski, “An Ultra-Low-Latency Guaranteed-Rate Internet for Cloud Services”. The well-known “Generalized Processor Sharing” (GPS) algorithm developed by Parekh and Gallager described in references [21] and [22] can also be used to compute a deterministic periodic schedule for memory 324, to control multiplexer 322 in each column.

### A D-Switch Using XQS and Flow-Labels

In this section, assume all packets in the forwarding-plane 94 use flow-labels. As described earlier, a packet header may contain about 16 bytes, comprising a stack for 5 flow-labels (each with 3 bytes), and with one byte used to point to a top of the stack. When a packet with a flow-label arrives at an input port 400, it is first buffered in buffer 304. It then moves to the decryption unit 306. This decryption unit will decrypt the packet header, as described earlier. The flow-table unit 308 will examine the packet header and extract the incoming flow-label. The incoming flow-label is used to access a flow-table 100, and extract several items: (i) an outgoing flow-label 102; (ii) an integer k 104 denoting the output port(k) from which the packet must depart; and (iii) the sub-queue-identifier 106, which identifies the sub-queue 330 in which the packet will be buffered.

As stated earlier, the operation of the decryption unit 306 in FIG. 12 remains unchanged from the decryption unit 306 shown in FIG. 11A, and the operation of the flow-table unit 308 in FIG. 12 remains unchanged from the flow-table unit 308 shown in FIG. 11A. Nevertheless, for clarity the operation of FIG. 12 is summarized next.

In FIG. 12, the integer k 104 is forwarded to the demultiplexer 310 in row(j) of the XQ switch 420, to control the demultiplexer 310. The memory 312 can store a periodic schedule, which identifies the time-slots within the period scheduling-frame, in which some VOQ in the row has a reservation to receive data. In accordance with one aspect of this disclosure, the sub-queue-identifier 106 will control the demultiplexer 326 shown in FIG. 11B, to identify the sub-queue 330 to receive the data within the appropriate VOQ(j,k) 320. The memory 324 to control the demultiplexer 326 shown in FIG. 11B, can now store a periodic schedule, which identifies the time-slots within the periodic scheduling-frame, in which some sub-queue 330 has a reservation to receive data.

In accordance with one aspect of this disclosure, the use of deterministic schedules for the D-switch 96 using XQs shown in FIG. 12 provides several benefits: (i) It provides each VOQ 320 with a deterministic rate of service, sufficient to satisfy its deterministic data-rate requirement; (ii) It provides each sub-queue 330 with a deterministic rate of service, sufficient to satisfy its deterministic data-rate requirement. (iii) It provides a deterministic schedule, to identify the time-slots in which data has reservations to arrive, for each input port 300 of a D-switch 96 in the forwarding-plane 94. (iv) It provides a deterministic schedule, to identify the time-slots in which data has reservations to arrive, for each sub-queue 330 of a VOQ 320, of D-switch 96 in the forwarding-plane 94. (v) It provides a deterministic schedule, to identify the time-slots in which data has reservations to be transmitted, over each directed edge 98 in the forwarding-plane 94. In accordance with another aspect of this disclosure, this plurality of deterministic schedules identifies the time-slots for the transmission of approved data for D-flows 22, approved by the AC/AC system 16 shown in FIG. 5A. Any other data transmissions at any other times represent anomalies, i.e., potentially packets from an external cyber-attacker. These anomalies are easily detected, as they violate a deterministic schedule, and the switch-controller 370 can inform the SDN control-plane 90 of the anomaly. Hence, the plurality of deterministic schedules results in a “Guaranteed Intrusion Detection System”.

In accordance with one aspect of this disclosure, the use of sub-queue-identifiers in a flow-table, and the use of sub-queues 330 within each VOQ 320, allows for a flexible design of a D-switch 96 using XQs. Each sub-queue 330a can buffer data for one particular D-flow 22, and hence service can be specified in a deterministic schedule for this particular sub-queue 330 and this particular D-flow 22. The use of sub-queue-identifiers also enables the use of sub-queues 330b, each of which buffers the data for a plurality of D-flows 22 that share the same traffic class. The data buffered within a sub-queue 330b can receive simple “First Come First Served” (FCFS) service.

### Detecting Unauthorized Packets

Each D-switch 96, whether it uses IQs as shown in FIG. 11A or XQs as shown in FIG. 12, can have a number of simple “security-controllers”, each comprising several counters, to monitor the packets that arrive on each incoming directed edge 98a. (These security-controllers are not shown in any figures.) The use of deterministic schedules implies that each D-switch 96 knows in advance, for each input port, the time-slots in which reservations for the arrival of data have been made by the SDN control-plane 90. A security-controller in each D-switch 96 can observe the arrivals on each directed edge 98a. If data arrives in a time-slot for which no arrival is scheduled, then an anomaly is detected. This anomaly may be malicious data from an external cyber-attacker. Hence, the security-controller can notify the switch-controller 370 of the anomaly. Data that arrives during a time-slot in which no arrival is scheduled can be saved in a temporary buffer, and forwarded to the SDN control-plane 90 for examination.

The security-controller can also count the number of arrivals to a VOQ 320, in each periodic scheduling-frame comprising F time-slots. If the number of observed arrivals is different from the expected number of arrivals, as indicated in the deterministic schedule controlling arrivals to the VOQ 320, then an anomaly is detected. The security-controller can notify the switch-controller 370 of the anomaly. The counting of packets can occur over any interval of F consecutive time-slots.

The security-controllers can also observe and count the arrivals to a sub-queue 330a or 330b. If data arrives to a sub-queue 330 in a time-slot for which no arrival is scheduled, an anomaly is detected. This anomaly may be malicious data from an external cyber-attacker. The security-controller can notify the switch-controller 370 of the anomaly. If the number of arrivals to a sub-queue 330 in one time interval comprising F time-slots exceeds the expected number of arrivals (or the expected number of departures) scheduled for that sub-queue 330 in one periodic scheduling-frame, then an anomaly has been detected. The security-controller can notify the switch-controller 370 of the anomaly.

### A Flow-Chart for the SDN Control-Plane

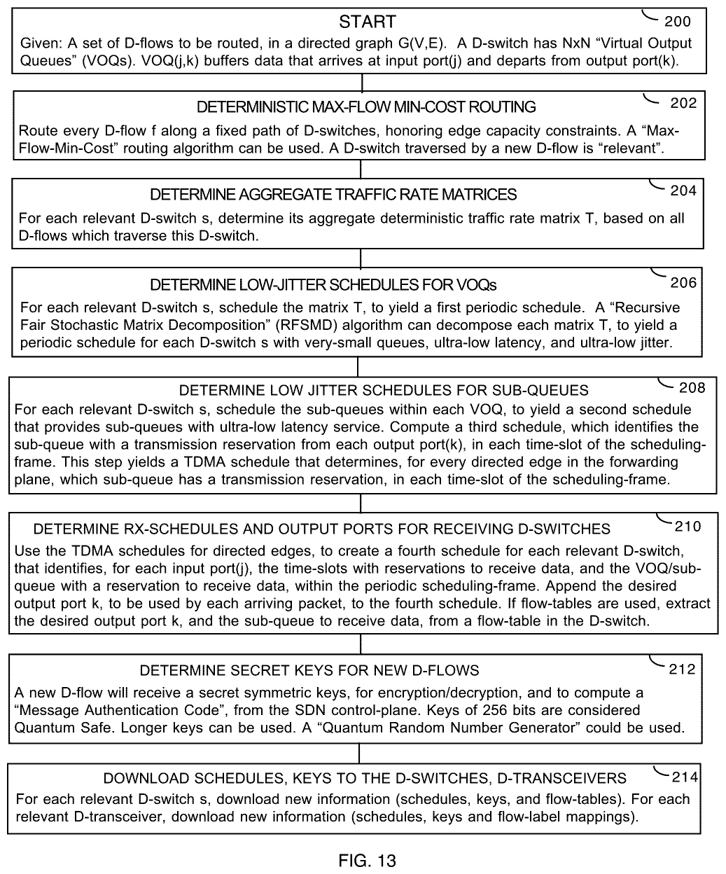

FIG. 13 illustrates a flow-chart for the proposed low-complexity SDN control-plane 90, given the following assumptions. At a D-transceiver 92, each D-flow 22 to be transmitted is buffered in a unique TX-queue 130. At a D-transceiver 92, each D-flow 22 to be received is buffered in a unique TX-queue 130. At a D-switch 96, each D-flow arriving at a VOQ 320 is buffered in a unique sub-queue 330a. Furthermore, flow-labels (and prioritized traffic classes) are not used in the forwarding-plane 94. The SDN control-plane controls the mapping of D-flows 22 to TX-queues 130, RX-queues 132, and sub-queues 330a within a VOQ 320.

Traditional SDN control-planes apply to traditional Best-Effort networks and are described in reference [28], entitled “Software-Defined Networking Security: Pros and Cons”, IEEE Communications Magazine, June 2015. A traditional and complex SDN control-plane can contain 10,000s of rules, which are stored in a very large memory. A traditional and complex SDN control-plane has rules on how best-effort switches should process IP packet headers, to identify Best-Effort IP traffic flows, and what to do with an IP packet once it is identified. A typical best-effort switch may store up to 10,000 rules, which may be insufficient to handle all traffic flows. In this case, additional rules for a switch are stored in the SDN control-plane. A best-effort switch which encounters a packet for which it has no rules must contact the SDN control-plane, and wait for rules to be downloaded to the switch. Clearly, the existence of thousands of rules which specify how to process packets and packet headers represents a significant complexity and performance penalty for traditional SDN control-planes and the best-effort switches. To summarize, traditional SDN control-planes are designed for traditional best-effort networks, which use thousands of rules to define their actions, specifically how best-effort switches should process packet headers.

According to one aspect of this disclosure, the proposed low-complexity SDN control-plane 90 is unique, in that it removes the burden of having switches in layer-3 process IP packer headers, and it performs a unique task that has not been applied to a large-scale network such as Internet in the past. It controls access to the bandwidth of every directed edge 98 in a low-complexity deterministic forwarding-plane 94. Furthermore, it controls the many simple D-switches 96 and D-transceivers 92 in the forwarding-plane 94. The D-switches 96 do not have thousands of rules to determine how they process packet headers. In contrast, the behavior of a D-switch 96 is simple and embedded in deterministic hardware, which is immutable and cannot be compromised by an external or internal cyber-attacker.

In FIG. 11, box 200 describes the start of the method. The SDN control-plane 90 processes a request for a set of new D-flows 22. The requests may originate from computers in one enterprise. Each request for a D-flow 22 includes a source node (D-transceiver 92a), a destination node (D-transceiver 92b), a deterministic data-rate requirement, and a security level specified by a secret symmetric key length in bits. (The request may also have requirements on the allowable delay, jitter and reliability.) The forwarding-plane 94 is modeled as a directed graph G(V,E), with a set of vertices V and a set of directed edges E. A D-transceiver 92 represents a source or destination node. A vertex in the graph represents a D-switch 96 or a D-transceiver 92. Each directed edge 98 in the graph represents a directed transmission line 98, and has a capacity constraint that must be honored. For example, a directed edge 98 may represent a fiber-optic transmission line with a capacity of 800 Gigabits/second (Gbps). A deterministic data-rate requirement can be specified as a number of time-slot reservations needed, in a periodic (repeating) scheduling-frame with F time-slots. The integer F may be any value, typically 1K, 4K, or 16K. If F=1,024, then the capacity of a directed edge 98, potentially 800 Gbps, is distributed over 1,024 time-slots, so each time-slot reservation represents a deterministic data-rate of approx. 800 Megabits/second (Mbps).

In box 202, the SDN control-plane 90 computes a fixed path for each new D-flow through one or more D-switches 96, from the source node 92a to the destination node 92b, which meets its data-rate requirement. The requirements on the delay, jitter and reliability, if specified by the requestor, must be satisfied as well. If the requirements cannot be met, the request for a new D-flow(s) is declined. The routing of traffic flows in networks is a well-known problem. This flow-chart uses “Maximum Flow Minimum Cost” routing algorithm, which maximizes the carried traffic, while minimizing the total cost. The algorithm is described in the reference [6] by T. H. Szymanski entitled “Maximum Flow Minimum Cost Routing in a Future Internet with Improved QoS Guarantees”. When a D-flow(f) 22 traverses a D-switch(s) 96, it arrives at a particular input port(j) 300, where j=A(f,s), and it departs from a particular output port(k) 340, where k=D(f,s). The fixed path for each new D-flow 22, and the matrices A and D at each D-switch 96, are determined by the SDN control-plane 90. Define a “relevant” D-switch 96 as a D-switch 96 which is traversed by one of these new D-flows 22.

In box 204, a deterministic traffic rate matrix T for each relevant D-switch 96 is determined. Let the D-switch 96 have degree N. The matrix T has size N×N, where element T(j,k) equals the sum of the data-rate requirements of the D-flows 22 that arrive at input port(j) 300 and depart from output port(k) 340, i.e., T(j,k) equals the data-rate requirement for VOQ(j,k) 320. Many scheduling methods require such a matrix. Each D-flow 22 has a data-rate requirement which can be represented by an integer between 1 and F. If a D-flow arrives at input port(j) and departs from output port(k), it increments T(j,k) by its deterministic data-rate requirement. The element T(j,k) will also be an integer between 0 and F. It cannot exceed F, since that would imply that the capacity constraint of some directed edge 98 has been violated.

In box 206, for a D-switch 96 with IQs, the SDN control-plane 90 can precompute a first deterministic periodic schedule, for each relevant D-switch 96. The first schedule specifies which VOQs 320 (if any), have reservations to remove data and forward said data to an output port 340, for each time-slot of the periodic scheduling-frame. This first schedule will provide each VOQ(j,k) 320 with a deterministic rate of service given by T(j,k), sufficient to meet its deterministic data-rate requirement.

According to the Birkhoff-von Neumann theorem established in 1946, a “bistochastic” matrix T can be decomposed into a weighted set of permutation matrices (or simply “permutations”). In a bistochastic matrix T, the elements T(j,k) are non-negative numbers, where the sum of each row is 1.0, and the sum of each column is 1.0. For each relevant D-switch 96, the traffic rate matrix T divided by F (i.e., T/F) is a bistochastic matrix, if it operates at 100% of its capacity. If it operates at less than 100% of its capacity, then the sums of the rows/columns will be less than 1.0. Hence, the BVN theorem indicates that the matrix T can be decomposed into a weighted set of permutations, even when it operates at 100% of its capacity.

For a D-switch 96 using IQs, as shown in FIG. 11A, this flow-chart uses a “Recursive Fair Stochastic Matrix Decomposition” (RFSDM) algorithm, explained in references [4] and [5] by T. H. Szymanski, entitled “An Ultra-Low Latency Guaranteed-Rate Internet for Cloud Services”, and “A Low-jitter Guaranteed-Rate Scheduling Algorithm for Packet-Switched IP Routers”, which were incorporated by reference earlier. The RFSMD algorithm will decompose the matrix T to yield a sequence of F permutation matrices (or simply “permutations”), which satisfy the data-rate requirements in the matrix T. Each permutation identifies up to N VOQs 320, which receive service in one time-slot. The sequence of F permutations yields a first periodic schedule of length F, stored in memory 382, which controls the state of the crossbar switch 380 shown in FIG. 11. The RFSMD algorithm yields a first periodic schedule with very small VOQ sizes, with very-low latency, and with very-low jitter. The method is also described in references [9] and [13] by T. H. Szymanski entitled “Methods to Achieve Bounded Buffer Sizes and Quality of Service Guarantees in the Internet Network”, and “Method and Apparatus to Schedule Packets through a Crossbar Switch with Delay Guarantees”.

In a D-switch 96 with XQs as shown in FIG. 12, the method to compute the above schedules can be simplified, as each column can be scheduled independently from the other columns. The method described in reference [10] by T. H. Szymanski entitled “Crossbar Switch and Recursive Scheduling” can also be used, to determine a schedule for each column. The well-known “Generalized Processor Sharing” algorithm developed by Parekh and Gallager, specified in references [21] and [22], entitled “A Generalized Processor Sharing Approach to Flow Control in Integrated Services Networks: The Single-Node Case”, and “A Generalized Processor Sharing Approach to Flow Control in Integrated Services Networks: The Multiple Node Case”, can also be used in this step.

In box 208, the SDN control-plane will precompute a second periodic schedule, for each relevant D-switch 96. A VOQ 320 can buffer packets for several different D-flows 22. A VOQ 320 contains several smaller “sub-queues” 330. Each sub-queue 330a buffers the packets of one distinct D-flow 22, and each sub-queue 330b buffers the packets of a plurality of D-flows 22 that share a traffic class. The second schedule will identify the sub-queue 330 (if any) within each VOQ 320 (if any), with a reservation to forward data to an output port, in each time-slot of the periodic scheduling-frame. (It can be stored in memory 334 in FIG. 11B.) The well-known “Generalized Processor Sharing” algorithm developed by Parekh and Gallager, specified in references [21] and [22], can be used in this step. Hence, the first schedule found in box 206 identifies the time-slots in which each VOQ 320 has reservations to forward data, and the second schedule identifies the sub-queue 330 within the VOQ 320 which has a reservation to forward data, when the VOQ 320 receives service. Each VOQ(j,k) 320 buffers packets that depart on output port(k) 340. When a packet of data arrives at an output port(k) 340, it can be transmitted over the outgoing directed edge 98b (i.e., an outgoing transmission line).

Each D-transceiver 92 consists of a plurality of TX-queues 130, each with a deterministic data-rate requirement. A first schedule for each D-transceiver 92 that is transmitting D-flows 22 can also be computed in this step, using the well-known “Generalized Processor Sharing” (GPS) algorithm described earlier. The schedule will identify a TX-queue 130 with a reservation to transmit data, in each time-slot of a periodic scheduling-frame.

The first and second schedules define the states of a D-switch 96, over the F time-slots in a periodic scheduling-frame. These 2 schedules guarantee 3 properties in each D-switch 96: (i) The traffic demands in the matrix T for said D-switch 96 are satisfied; (ii) Every VOQ(j,k) 320 in said D-switch 96 satisfies its deterministic data-rate requirement given by T(j,k), with very-low latency and jitter; and (iii) Every D-flow 22 traversing said D-switch 96 satisfies its deterministic data-rate requirement, with very-low latency and jitter. The schedule for a D-transceiver 92 will provide each TX-queue 130 with deterministic service, sufficient to meet its deterministic data-rate requirement.

Box 208 will also determine a third periodic schedule for each relevant D-switch 96. The previous 2 schedules can be used to compute a third schedule that identifies, for each relevant D-switch 96 and for each output port(k) 340, which sub-queue 330 has a reservation to transmit data from that output port(k) 340, in each time-slot of the scheduling-frame. Hence, every directed edge 98 in the forwarding-plane 94 can now be assigned a TDMA schedule, which identifies the sub-queue 330 (if any) with a reservation to a transmit data over that directed edge 98, in each time-slot of the periodic scheduling-frame.

Box 210 will determine a fourth schedule for each relevant D-switch 96. The third schedule determines a TDMA schedule for every relevant D-switch 96 and every output port(k) 340. Data transmitted over a directed edge 98 will be received either by (a) a receiving D-switch 96, or (b) or a receiving D-transceiver 92. Call a receiving input port(j) 300 of a receiving D-switch 96, the “receiving device” in this paragraph. Also call a receiving D-transceiver 92, the “receiving device” in this paragraph. Hence, the third schedule determines highly-relevant information for the receiving-device. The third schedule determines: (i) the time-slots in which the receiving-device has reservations to receive data, within the periodic scheduling-frame; (ii) the identity of the sub-queue 330 (if any) that has reservations to arrive at the receiving-device, when an arrival is scheduled.

Assume that flow-labels and prioritized traffic classes are not used. Therefore, there are no traffic classes in the forwarding-plane 94, and each sub-queue 330 buffers data for one particular D-flow 22. Hence, in box 210 the SDN control-plane 90 can define a fourth schedule for each relevant D-switch 96, that identifies for each input port(j) 300, the time-slots in which that input port(j) 300 has reservations to receive data, and (ii) the D-flow 22 (if any) that has a reservation to arrive at that input port(j) 300, when an arrival is scheduled. Similarly, the SDN control-plane 90 can define a second schedule (called the RX-schedule) for each relevant D-transceiver 92, that identifies the time-slots in which that D-transceiver 92 has reservations to receive data in the periodic scheduling-frame, and (ii) the D-flow (if any) that has a reservation to arrive at the D-transceiver 92 when an arrival is scheduled, for each time-slot with a reservation.

The output port(k) 340 that an arriving D-flow(f) 22 must depart from is given by k=D(f,s), where the matrix D was found in box 200. Hence, the desired output port(k) 340 can be added to the fourth schedule, for each time-slot in which data arrives. These 4 schedules imply a significant result. Each D-switch 96 does not need to process unencrypted and unauthenticated IP packet headers. The behavior of a D-switch 96 is completely predetermined, by the deterministic nature of the system. The observation that a deterministic system results in predetermined behaviour, which can strengthen cyber-security, is explained in depth in reference [1] by T. H. Szymanski, entitled “The “Cyber-Security via Determinism” Paradigm in a Quantum Safe Zero Trust Deterministic Internet of Things”.

As described earlier, the processing of IP packet headers in layer three 12 yields many cyber-security vulnerabilities, that have existed in the Consumer IoT 4 for many decades. These vulnerabilities can be removed, for the first time in decades, by removing the need to process IP packet headers in layer three 12. As a result, packets in the forwarding-plane 94 can be completely encrypted at the source (a D-transceiver 92), and remain encrypted while they traverse the network. This ability to encrypt all packets in a D-VPN greatly strengthens cyber-security.

Assume that flow-labels are used. Therefore, multiple traffic classes may be supported in the forwarding-plane 94, and each sub-queue 330b can buffer data for a plurality of D-flows 22, which share the same prioritized traffic class. Hence, in box 210 the SDN control-plane 90 can define a fourth schedule for each relevant D-switch 96, that identifies for each input port(j) 300, the time-slots in which that input port(j) 300 has reservations to receive data. When a packet arrives at the D-switch 96, its incoming flow-label is extracted, and used to access a flow-table 100. The flow-table yields: (i) the outgoing flow-label 102 to be inserted into the packet-header; (ii) an integer k 104 denoting output port(k) from which the packet must depart; (iii) sub-queue-identifier 106, to identify the sub-queue 330b to receive the packet. The integer k also identifies the VOQ 320 to receive the incoming packet.

In Box 212, the SDN control-plane 90 will determine secret symmetric keys, for each newly established D-flow 22. According to one aspect of this disclosure, the SDN control-plane 90 should support multiple encryption algorithms, with varying secret key lengths, to provide diversity. Data can be encrypted using the “Advanced Encryption Standard” (AES), or the Chacha20 cipher, as described earlier. (Any other Quantum Safe cipher can be used.). Each packet may have a “Message Authentication Code”, computed with the Poly1305 authentication algorithm (or any other safe authentication algorithm). The SDN control-plane 90 can allow an entity requesting a new D-flow 22 to request the encryption algorithm, and the length of the secret keys. Box 212 can then generate the secret keys, using a high quality computer program to generate pseudo-random numbers. The encrypted output of the AES or Chacha20 ciphers represent high quality pseudo-random numbers, and they can be used. Any other computer program that generates high-quality pseudo-random numbers can also be used. Alternatively, the SDN control-plane 90 can have its own “Quantum Random Number Generator” hardware, to generate secret keys. A “Quantum Random Number Generator” is described in the reference[29] by Haw, et al, entitled “Maximization of extractable randomness in a quantum random-number generator”, which was incorporated by reference earlier.

Box 212 can also use the IETF (Internet Engineering Task Force) “Authenticated Encryption” (AE) algorithm (or any other Quantum Safe algorithms) to encrypt and authenticate each packet. The IETF Authenticated Encryption algorithm is described in reference [26] by McGrew, entitled “An Interface and Algorithms for Authenticated Encryption”, which was incorporated by reference earlier.

The requestor of a new D-flow 22 can request the cipher and a length for the secret symmetric key for each new D-flow 22. Several levels of security seem warranted, given the threat posed by Quantum Computers (more security levels can be added). A very-strong security level can use secret key lengths with 256 bits. To achieve exceptionally-strong security, the private keys can have lengths between 512 and 1024 bits. To achieve even stronger security, the private keys can have lengths greater than 1024 bits. These keys are managed by the SDN control-plane 90, so the use of longer keys poses no burden to the end-users. The use of longer keys in the AES cipher is described in reference [1] by T. H. Szymanski, entitled “The “Cyber-Security via Determinism” Paradigm in a Quantum Safe Zero Trust Deterministic Internet of Things”.

Box 214 will arrange for the periodic schedules and secret keys to be downloaded to the relevant D-switches 96 and D-transceivers 92 in the forwarding-plane 94. If a new D-flow 22 traverses a D-switch 96, the deterministic schedules in the relevant D-switch 96 will change, and should be updated by the SDN control-plane 90. If a D-flow 22 is removed from a D-switch 96, the deterministic schedules in the D-switch 96 will change, and should be updated by the SDN control-plane 90. When a new D-flow 22 is added to the forwarding-plane 94, the source D-transceiver 92 should receive an updated transmission schedule, and secret symmetric keys. When a new D-flow 2 is added to the forwarding-plane 94, the destination D-transceiver 92 should receive an updated reception schedule, and secret symmetric keys. When a D-flow 22 is removed from the forwarding-plane 94, the D-transceivers 92 at the source and destination should receive updated schedules, and the secret keys can be destroyed.

The flow-chart shown in FIG. 13 can process requests for the addition of a single new D-flow 22, or the addition of a set of new D-flows 22. It can easily be modified to process requests for the removal of one D-flow 22 or several D-flows 22 from the forwarding-plane 94; the steps of the flow-chart remain the same, except that D-flows 22 are removed (rather than added) from the directed edges 98 and traffic rate matrices T. The D-flows 22 are removed from schedules (rather than added to schedules). Secret keys can be deleted, rather than added.

When flow-labels and prioritized traffic classes are not used in the forwarding-plane 94, the flow-chart in FIG. 13 provides excellent service to individual D-flows 22. However, a large number of sub-queues 330a may be required in a D-switch 96, given that every D-flow 22 traversing a D-switch is allocated its own sub-queue 330a. To reduce the number of sub-queues 330 needed in a D-switch 96, the SDN control-plane 90 can use flow-labels in the forwarding-plane 94, and define several classes of “prioritized traffic”.

A sub-queue 330b buffers data for a plurality of D-flows 22 that share the same traffic class. Packets in the sub-queue 330b can be serviced in a “First Come First Served” (FCFS) order, which simplifies the hardware needed in a D-switch 96. A FCFS queue is relatively easy to implement using two memories: Memory A buffers incoming packets in a linear order, while memory B transmits buffered packets in a linear order. When memory B is empty, the roles reverse, i.e., memory B buffers incoming packets in a linear order, while memory A transmits buffered packets in a linear order. When memory A is empty, the roles reverse once again.

### Public Key and Symmetric Key Encryption

A Public key encryption algorithm requires 2 keys to secure a connection to a destination; (i) a Public key which is publically available, and (ii) a Private key which only the destination knows. In the RSA public key scheme, a source can encrypt a packet to a destination using its known public key, and only the destination can decrypt the packet using its secret private key. Public key encryption algorithms are typically complex and slow. They are often used in the Consumer IoT 4 to transfer a secret “symmetric” key between 2 entities, which can be used to encrypt and decrypt data faster. Thereafter, the 2 entities can communicate much more efficiently using their secret symmetric key, using a “Symmetric key” encryption scheme. In the proposed Industrial IoT 6, the SDN control-plane 90 can use a Quantum Safe public key encryption scheme, to communicate with the D-switches 96 and D-transceivers 92. The US NIST (“National Institute for Standards in Technology”) is standardizing one (or more) Quantum Safe public key technologies, including the CRYSTALS-Kyber algorithm. The SDN control-plane 90 can establish a first communications channel to a D-switch 96 or D-transceiver 92, using public key technology, i.e., the CRYSTALS-Kyber algorithm. Once a secure Quantum Safe channel is established, it can then assign a secret symmetric key to each D-switch 96 or each D-transceiver 92, over the secure Quantum Safe communications channel. It can thereafter communicate with the D-switches 96 and D-transceivers 92 very efficiently, using the secret symmetric ciphers.

The proposed SDN control-plane 90 can create millions of distinct “Deterministic Virtual Private Networks” (D-VPNs) in the forwarding-plane 94. Each D-VPN is a collection of D-flows 22, organized into a single “virtual private network”, typically associated with one enterprise. The D-flows 22 in a D-VPN have full immunity to congestion and DoS/DDoS attacks, since access to the forwarding-plane 94 is carefully controlled by the SDN control-plane 90. All D-VPNs are non-interfering, which improves performance and security.

The communications within a D-VPN are encrypted with Quantum Safe ciphers. The D-flows within a D-VPN have full immunity to congestion, DoS/DDoS attacks, and all known cyber-attacks, since access to the forwarding-plane 94 is carefully controlled by the AC/AC control system 19 within the SDN control-plane 90.

In accordance with one aspect of this disclosure, the proposed SDN control-plane can establish many D-VPNs into the proposed forwarding-plane 94 operating in sub-layer 3a, and it can support D-flows 22 between IP-routers that operate in layer 3. Two IP-routers in layer 3 can then forward traffic between themselves, over D-flows 22 with ultra-low latency and with very strong cyber-security. This migration of traffic, from an inefficient layer-3 IP, to a highly-efficient forwarding-plane 94 in sub-layer-3a, can save significant sums of money.

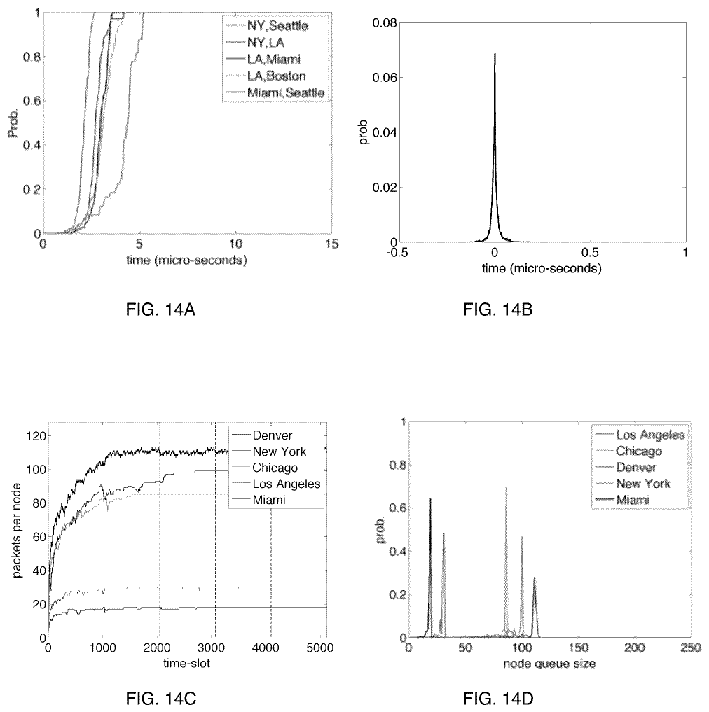

A software simulator was developed to verify the correct operation and performance of the forwarding-plane 94 in the USA topology, as shown in FIG. 7. Approx. 310 D-flows were established in the forwarding-plane 94. All links were operated at heavy loads, with an average of 93% link utilization, as described in reference [1]. FIG. 14A illustrates the queuing delay CDF (cumulative distribution function) for several D-flows 22 in the USA topology shown in FIG. 7. Assume the optical links have a rate of 200 Gigabits per second (Gbps), and a maximum-size packet has 1,000 bytes. A time-slot has sufficient time to transmit a maximum-size packet, and the duration of a time-slot is therefore about 41 nanoseconds, and the duration of a scheduling frame with F=1,024 time-slots is about 41 microseconds. The queuing delays between cities are less than 2 microseconds, an extremely low delay. The delay of the fiber between 2 cities such as Miami and Seattle will exceed 20 milliseconds, so the queuing delay within the deterministic packet-switches is over 1,000 times smaller than the fiber delay.

FIG. 14B illustrates the average packet jitter over the USA topology, which is exceptionally small. The average jitter is less than 1 microsecond. FIG. 14C illustrates the evolution of the number of packets buffered per D-switch (called the ‘Node Queue’ size), starting from an empty switch, versus time. (A node is also called a D-switch.) The number of packets buffered in a D-switch reaches a steady-state deterministic pattern after about 3,000 time-slots. The D-switch 96 with the most packets buffers less than 120 packets in this experiment. Recall that in the Consumer IoT 4, an IP router can buffer 10s of millions of IP packets. The use of an AC/AC control system 19 and a deterministic forwarding-plane 94 has reduced the amount of buffering required in a D-switch, to a small number of packets, about 120 in this example.

FIG. 14D illustrates the distribution of the number of buffered packets in a D-switch, in steady state, for selected cities. All D-switches buffer less than 120 packets in this experiment, which can be between 100,000 and 1 million times less buffering than used in a typical BE-IoT router using today's design techniques.

### Integrated Circuit Packages

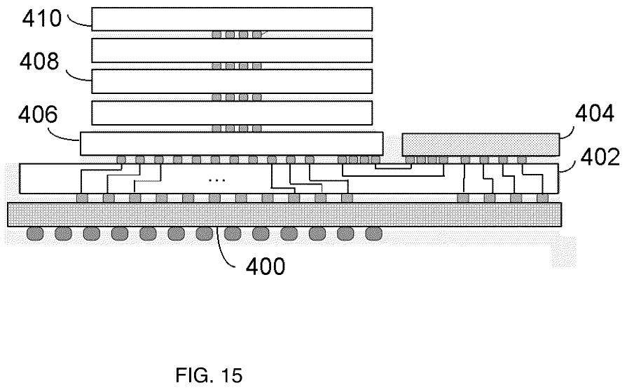

A D-switch 96 may comprise a ‘Field Programmable Gate Array’ (FPGA) die, and one or more Silicon-Photonics transceiver die, interconnected and packaged onto a traditional Integrated Circuit (IC) package. A typical IC package is the “Ball Grid Array” (BGA) package 400, as shown in FIG. 15. A “Silicon Interposer” 402 is a silicon substrate which can interconnect multiple die. A Silicon Photonics transceiver die 404 will implement the “electrical-to-optical” (EO) converters 80, and the “optical-to-electrical” (OE) converters 82, needed in the input ports and output ports of a D-switch 96. An FPGA die 406 is shown in FIG. 15. In general, a silicon interposer 402 may interconnect one or more FPGA die 406, one or more silicon photonics transceiver die 404, one or more memory die 408, and other die 410. In accordance with one aspect of this disclosure, the ability to migrate the complex tasks of routing and scheduling of layer-3 packets into the SDN control-plane 90, results in a dramatic simplification of the D-switch 96. A single D-switch 96 will not buffer 10s of millions of packets. In contrast, it may buffer a few hundred packets. A single D-switch can thus be realized with one (or a few) FPGA integrated circuits. The ability to fabricate a D-switch 96 using FPGAs and integrated circuit packaging technologies, such as a BGA package, can result in a significant cost savings.

A “Silicon Bridge” is a small silicon die which is placed over 2 die to interconnect them, much like a bridge over water. Multiple silicon bridges can also be used interconnect multiple VLSI die, and the resulting collection of interconnected die can be packaged using existing packaging technologies, i.e., a “Ball Grid Array” (BGA) package.

### All-Optical Deterministic Forwarding-Plane

The proposed AC/AC controller 19 can also control an “optical” deterministic forwarding-plane. The technology exists to buffer bits of information in an integrated circuit, in optical format. In an integrated circuit, information can be transferred between entities by transmitting light into “optical waveguides”. Hence, the technology exists to build simple deterministic packet switches (D-switches), that store data in “all-optical” format. Given such “optical” D-switches, one can construct an “optical” deterministic forwarding-plane. The ability of the D-switches to avoid processing IP packet headers results in a significant advantage, that makes an “optical” deterministic forwarding-plane feasible. The proposed AC/AC controller 19 can control such an “optical” deterministic forwarding-plane, to achieve excellent performance with exceptionally-strong cyber-security.

### Wireless Deterministic Forwarding-Plane

The proposed AC/AC controller 19 can also control a wireless deterministic forwarding-plane, for a “Local Area Network” (LAN), or “Metropolitan Area Network” (MAN). A deterministic wireless forwarding-plane without the proposed AC/AC control system 19, was proposed in reference [12] by T. H. Szymanski, U.S. Pat. No. 9,042,380 B2, “Delay and Jitter Limited Wireless Mesh Network Scheduling”, issued Oct. 18, 2016, (which was incorporated by reference earlier). It describes a deterministic wireless forwarding-plane using deterministic packet switches using “Output Queues” (OQs). It describes the use of periodic schedules that indicate when wireless traffic can be transmitted from the deterministic packet switches, to minimize wireless interference, congestion, and to reduce buffer sizes. It describes methods to compute periodic collision-free schedules for multiple deterministic wireless packet switches operating in a wireless local area network.

An AC/AC control system 19 can be added to the deterministic wireless forwarding-plane described in reference [12], to control access to the bandwidth of the wireless forwarding-plane. In particular, for a packet to be accepted at a wireless D-transceiver 92, it must be successfully decrypted, using a Quantum Safe cipher. Cyber-attackers will be unable to crack the Quantum Safe cipher, and will thus be unable to successfully transmit data to a D-transceiver, when the AC/AC controller 19 controls access to the bandwidth of the wireless forwarding-plane 94.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modifications within its scope, as defined by the claims.

For example, the buffers and queues in the D-switches have been described as VOQs, and sub-queues. In practice, all these queues may reside in the same memory, or a few memories, and may be defined through pointers to memory. Multiple schedules have been described to control a D-switch, which are stored in multiple memories. However, many schedules can be combined into a single schedule which stores more information, which is stored in one memory. Hence, the number of memories and the number of schedules can be reduced, by combining schedules.

The D-transceiver has been described as an integrated unit, comprising logic for the deterministic transmission of D-flows, and logic for the deterministic reception of D-flows. However, the D-transceiver can also be viewed as comprising a deterministic transmitter (D-transmitter), and a distinct deterministic receiver (D-Receiver), by one with ordinary skill in the art.

Given the threat posed by Quantum Computers, the number of symmetric key ciphers and public key ciphers can be expected to grow over time. To provide diversity, the proposed AC/AC system 19, the SDN control-plane 90 and the D-transceivers 92 should support the use of a number of ciphers, and a number of secret key lengths.

What is claimed:

1. A “Deterministic Receiver” (D-Receiver) module for receiving encrypted data associated with one or more “Authenticated Encrypted Deterministic Channels” (AEDCs) from a forwarding-plane of “deterministic packet switches” (D-switches), while minimizing the reception of unauthorized data, given a periodic (repeating) scheduling-frame comprising F time-slots for positive integer F, wherein each EDC is associated with a deterministic (or guaranteed) data-rate requirement, comprising:
a “computer system bus interface” unit, operable to forward authorized data received from said forwarding-plane to an external computer system;
a first memory, which is partitioned into a plurality of “Receive-Queues” (RX-Queues), wherein each RX-queue buffers authorized data associated with one AEDC that has been received from said forwarding-plane;
a second memory, to buffer a plurality of secret keys, wherein each AEDC to be received is associated with one (or more) secret keys;
a third memory, to store a deterministic periodic schedule;
a “decryption unit” operable to decrypt data that has been received from said forwarding-plane;
a demultiplexer, to forward authorized data received from said forwarding-plane into one of said plurality of RX-queues;
a controller, wherein said controller is operable to receive encrypted data from, and send encrypted data to, an external control-plane;
wherein said controller is operable to receive a deterministic periodic “Reception Schedule” (RX-schedule) from said external control-plane, wherein said RX-schedule specifies which RX-Queue, if any, has a reservation to receive data in each time-slot of said periodic scheduling-frame, and store said RX-schedule in said third memory;
wherein said controller is operable to receive one (or more) secret keys from said control-plane for each AEDC to be received from said forwarding-plane and store said key(s) into said second memory;
wherein said controller provides said secret keys to said decryption-unit, to decrypt the data associated with each AEDC when it is received from said forwarding-plane;
wherein said RX-Schedule provides each AEDC to be received with a deterministic number of time-slot reservations for receiving data in said periodic scheduling-frame, to meet its deterministic data-rate requirement;
wherein data which is received in a time-slot for which no reservation for the reception of data has been made is classified as “unauthorized data” and will be deleted;
wherein data which is received in a time-slot for which a reservation to receive data has been made, will be decrypted in said decryption unit;
wherein data which fails the decryption process (by yielding pseudo-random numbers after decryption) will be classified as “unauthorized data” and will be deleted;
wherein data which passes the decryption process, given that Quantum Safe ciphers are used, is classified as “authorized data” and will be forwarded to the appropriate RX-queue by said demultiplexer.

2. The “Deterministic Receiver” (D-Receiver) module of claim 1, further comprising:
an “authentication unit” operable to compute a “message authentication code” (MAC) for data that has been received from said forwarding-plane, to verify its authenticity;
wherein said controller provides said secret keys to said decryption-unit and said authentication unit, to decrypt and authenticate the data associated with each AEDC when it is received from said forwarding-plane;
wherein data which is received in a time-slot for which a reservation to receive data has been made, will be decrypted in said decryption unit and its authenticity will be examined by said authentication unit;
wherein data which fails the decryption process (by yielding pseudo-random numbers after decryption) will be classified as “unauthenticated data” and will be deleted;
wherein data which fails the authentication verification process (by yielding an incorrect MAC) will be classified as “unauthenticated data” and will be deleted;
wherein data which passes the decryption process and passes the authentication process (such that the decrypted data contains a valid MAC which is identical to the MAC computed by said authentication unit) is classified as “authenticated data” and will be forwarded to the appropriate RX-queue by said demultiplexer.

3. The D-Receiver module of claim 1, wherein for each AEDC to be received with a deterministic data-rate requirement equivalent to T time-slot reservations per periodic scheduling-frame, said RX-schedule provides said AEDC with at least T/2−J time-slot reservations, and at most T/2+J time-slot reservations, in each half of said RX-Schedule with a duration of F/2 time-slots, wherein J is an integer representing the “allowable difference”, and wherein for large F, J can equal T/8 or T/4.

4. The D-Receiver module of claim 1, further comprising an “optical-to-electrical” (OE) converter, to convert optical signals into electrical signals for reception from a fiber-optic transmission line.

5. The D-Receiver module of claim 1, wherein said D-Receiver is packaged onto a single integrated circuit package.
